(19) United States
(12) Patent Application Publication
(10) Pub. No.: US 2026/0249435 A1
(43) Pub. Date: Aug. 27, 2026

(54) RING CHANGE TOOLING AND METHODS

(71) Applicant: Mainspring Energy, Inc., Menlo Park, CA (US)

(72) Inventors: Jules Savoyat, San Francisco, CA (US); Andrew Douglas Noto, Los Gatos, CA (US)

(21) Appl. No.: 18/854,504

(22) PCT Filed: Apr. 4, 2023
(86) PCT No.: PCT/US2023/017424

§ 371 Date: Oct. 4, 2024

Related U.S. Application Data
(60) Provisional application No. 63/327,085, filed on Apr. 4, 2022.

(51) Int. Cl. B25B 27/12; B25B 27/00

(52) U.S. Cl. CPC B25B 27/12; B25B 27/0028

(57) ABSTRACT

A tool is configured to engage with an end of a cylinder in which a piston is arranged to move, or with the piston itself, and constrains or releases segments of a sealing ring assembly. The tool may include retainers or other features for limiting displacement of one or more segments as they are installed or removed from a groove of the piston. Retainers may be configured to achieve multiple positions to allow constraining or releasing of each segment such that the other segments are held in place.

### CROSS-REFERENCE TO RELATED APPLICATIONS

The present disclosure is directed towards integrated linear generator systems and aspects thereof. This application claims the benefit of U.S. Provisional Patent Application No. 63/327,085 filed Apr. 4, 2022, the disclosure of which is hereby incorporated by reference herein in its entirety.

### BACKGROUND

Pistons include rings for sealing and, depending on the configuration of the rings, techniques may be beneficial for systematically installing or removing the rings.

### SUMMARY

In some embodiments, the present disclosure is directed to an apparatus that includes at least one element configured to interface to an end of a cylinder, and a plurality of retainers configured to constrain a sealing ring assembly. In some embodiments, in a first configuration, at least one retainer of the plurality of retainers constrains at least one segment of the sealing ring assembly in a groove of a piston. In some embodiments, in a second configuration, the at least one retainer of the plurality of retainers is axially offset from at least one segment such that the at least one segment is radially removeable. In some embodiments, the at least one element comprises at least two azimuthal segments, each extending at least partially around the sealing ring assembly. In some embodiments, the sealing ring assembly is arranged in a groove of the piston and is configured to seal against both a land of the piston and a bore of the cylinder, and the at least one element includes at least one mounting feature configured to be engaged with the cylinder. In some embodiments, the apparatus includes a flange extending radially inward from the at least one element into a bore of the cylinder to constrain axial displacement of the piston into the bore of the cylinder, and the flange is configured to block the piston from moving into the bore.

In some embodiments, each respective retainer includes a respective first feature, and the at least one element includes a plurality of second features. In some embodiments, the apparatus includes a plurality of tethers that couple each respective first feature to a respective second feature of the plurality of second features such that each respective retainer is tethered to the at least one element. For example, the tethers may include metal wire, plastic wire, or any other suitable material. In some embodiments, the plurality of retainers each include a respective head and a respective pin, the at least one element includes a plurality of axial holes, each respective pin is configured to move axially in a respective axial hole of the plurality of axial holes, and each respective head is configured to contact the sealing ring assembly to prevent radial displacement of one or more segments of the sealing ring assembly. In some embodiments, the plurality of retainers each include a respective disc configured to contact the sealing ring assembly to prevent radial displacement of one or more segments of the sealing ring assembly. In some embodiments, the plurality of retainers each include a respective asymmetric washer configured to achieve a first angular orientation and a second angular orientation. For example, in some embodiments, at the first angular orientation, the asymmetric washer is configured to prevent radial displacement of one or more segments of the sealing ring assembly. In a further example, in some embodiments, at the second angular orientation, the asymmetric washer is configured to allow radial displacement of the one or more segments of the sealing ring assembly. In some embodiments, the plurality of retainers each include a respective head and at least two respective pins, each respective head includes a respective radial width and a respective azimuthal length, and the respective radial width is less than the respective azimuthal length. In some embodiments, each retainer of the plurality of retainers is axially biased by a spring.

In some embodiments, the present disclosure is directed to an apparatus that includes a first element configured to engage with a first ring segment of a sealing ring assembly to form a first subassembly, and a second element configured to engage with the first element and to engage with a second ring segment of the sealing ring assembly to form a second subassembly. In some embodiments, the first and the second subassemblies are configured to be engaged with each other and arranged azimuthally around a groove of a piston. In some embodiments, the first and second element are configured to be removed before operation. In some embodiments, the first element includes at least one first feature configured to be engaged with a mating feature of the first segment, and the second element includes at least one second feature configured to be engaged with a mating feature of the second segment. In some embodiments, the first element includes at least one first mounting feature configured to be engaged with the piston, and the second element includes at least one second mounting feature configured to be engaged with the piston. In some embodiments, the apparatus includes at least one retainer configured to interface with the first segment and with the first segment to retain the first segment and the first element together in at least one degree of freedom.

In some embodiments, the present disclosure is directed to a method for servicing a sealing ring assembly that seals against a piston and a cylinder of a linear generator. In some embodiments, the method includes engaging a respective segment of the sealing ring assembly to a respective element of a plurality of elements of a ring tool, configuring the plurality of elements such that the sealing ring assembly is arranged in a groove of piston, and positioning the piston such that the sealing ring assembly is laterally bound by the cylinder rather than the ring tool. In some embodiments, the method includes blocking the piston from entering the cylinder using a flange. In some embodiments, the method includes removing the ring tool after positioning the piston (e.g., before operation of the linear generator).

In some embodiments, the present disclosure is directed to a method for servicing a sealing ring assembly that seals against a piston and a cylinder of a linear generator. In some embodiments, the method includes arranging a ring tool at an axial end of the cylinder, positioning the piston such that the sealing ring assembly is axially proximal to the ring tool, constraining at least one segment of the sealing ring assembly using a plurality of retainers of the ring tool, and actuating one or more retainers of the plurality of retainers to allow radial displacement of the at least one segment. In some embodiments, the method includes installing a ring sleeve to retain the sealing ring assembly during the positioning the piston, and arranging the ring tool at the axial end of the cylinder is performed after installing the ring sleeve. In some embodiments, constraining the at least one segment using the plurality of retainers includes achieving a first respective axial position of each respective retainer of the plurality of retainers, and actuating the one or more retainers of the plurality of retainers to allow radial displacement of the at least one segment includes achieving a second respective axial position of each respective retainer of the plurality of retainers. In some embodiments, the method includes maintaining at least one retainer exclusive of the plurality of retainers to constrain another segment of the sealing ring assembly exclusive of the at least one segment.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a cross-sectional side view of an illustrative piston-cylinder assembly, with a tool installed, in accordance with some embodiments of the present disclosure;

FIG. 2 shows a cross-sectional side view of an illustrative generator assembly, in accordance with some embodiments of the present disclosure;

FIG. 3 shows a portion of an illustrative generator assembly, with reaction section pistons at two respective axial positions, in accordance with some embodiments of the present disclosure;

FIG. 4 shows a cross-sectional view of an illustrative gas spring system, including a sealing ring assembly, in accordance with some embodiments of the present disclosure;

FIG. 5 shows a cross-sectional view of an illustrative generator assembly portion, in accordance with some embodiments of the present disclosure;

FIG. 6 shows a cross-sectional view of an illustrative generator assembly portion, with the seal within a ring compressor, in accordance with some embodiments of the present disclosure;

FIG. 7 shows a cross-sectional view of the illustrative generator assembly portion of FIG. 6, with a portion of the seal outside of the ring compressor, in accordance with some embodiments of the present disclosure;

FIG. 8 shows a face view of an illustrative sealing ring assembly and springs, in accordance with some embodiments of the present disclosure;

FIGS. 9-10 shows two side cross-sectional views of an illustrative piston-cylinder interface, in accordance with some embodiments of the present disclosure;

FIG. 11 shows cross-sectional views of the illustrative piston-cylinder interface of FIGS. 9-10 and a tool, in accordance with some embodiments of the present disclosure;

FIG. 12 shows a perspective view of an illustrative strap for maintain ring configuration, in accordance with some embodiments of the present disclosure;

FIG. 13 shows a perspective view of an illustrative band for maintain ring configuration, in accordance with some embodiments of the present disclosure;

FIG. 14 shows a perspective view of an illustrative tool having retainers, in accordance with some embodiments of the present disclosure;

FIG. 15 shows a perspective view of an illustrative tool having retainers arranged at the end of a cylinder, in accordance with some embodiments of the present disclosure;

FIG. 16 shows a cross-sectional side view of the illustrative tool and cylinder of FIG. 15, in accordance with some embodiments of the present disclosure;

FIG. 17 shows a perspective view of an illustrative tool having magnets, in accordance with some embodiments of the present disclosure;

FIG. 18 shows a perspective view of an illustrative tool having contoured retainers, in accordance with some embodiments of the present disclosure;

FIG. 19 shows a perspective view of an illustrative tool having retainers with varying thicknesses, in accordance with some embodiments of the present disclosure;

FIG. 20 shows a perspective view of an illustrative tool having rotatable retainers, in accordance with some embodiments of the present disclosure;

FIG. 21 shows a perspective view of an illustrative tool having arc-shaped retainers, in accordance with some embodiments of the present disclosure;

FIG. 22 shows perspective views of a portion of an illustrative tool having hinge features, in accordance with some embodiments of the present disclosure;

FIG. 23 shows perspective views of a portion of an illustrative tool having a hinge pin, in accordance with some embodiments of the present disclosure;

FIG. 24 shows a side cross sectional view of an illustrative tool having a flange and installed on a cylinder, in accordance with some embodiments of the present disclosure;

FIG. 25 is a flowchart of an illustrative process for servicing rings, in accordance with some embodiments of the present disclosure;

FIG. 26 is a flowchart of an illustrative process for servicing rings, in accordance with some embodiments of the present disclosure;

FIG. 27 is a flowchart of an illustrative process for servicing rings, in accordance with some embodiments of the present disclosure;

FIG. 28 shows a series of cross-sectional views of a region of a linear generator during ring servicing, in accordance with some embodiments of the present disclosure;

FIG. 29 shows a series of face views of a ring tool, a piston, and a ring sleeve during installation, in accordance with some embodiments of the present disclosure;

FIG. 30 shows a series of views of a ring tool, positioner, and piston during installation, in accordance with some embodiments of the present disclosure; and

FIG. 31 shows aspects of an illustrative ring tool, in accordance with some embodiments of the present disclosure.

### DETAILED DESCRIPTION

In some embodiments, the present disclosure is directed to tools for servicing sealing ring assemblies. For example, the sealing ring assemblies may be included in piston-cylinder assemblies of linear generator systems configured to provide electrical work (i.e., electricity) from an input of a fuel and oxidizer. In some embodiments, the present disclosure is directed to methods and systems for installing, removing, servicing, or otherwise interacting with a sealing assembly configured to seal between a bore of a cylinder and a piston. In an illustrative example, in some circumstances, segments of a sealing ring assembly may have a limited field life, and may be changed regularly. Accordingly, it may be desired to simplify servicing based on a simple work instruction, to reduce service time. In some circumstances, segments may be fragile (e.g., brittle) and relatively expensive, and it would be desired to minimize the risk of the segments falling and breaking during servicing.

To illustrate, a tool may be a custom solution that allows a quick and easy installation, minimizing or otherwise improving the risk of failure (e.g., segment breakage), the number of people and skills involved, particularized design, or a combination thereof. For example, time savings may be important in the field, to allow a fleet of technicians to use a tool with minimal support and training in the context of one or more ring types.

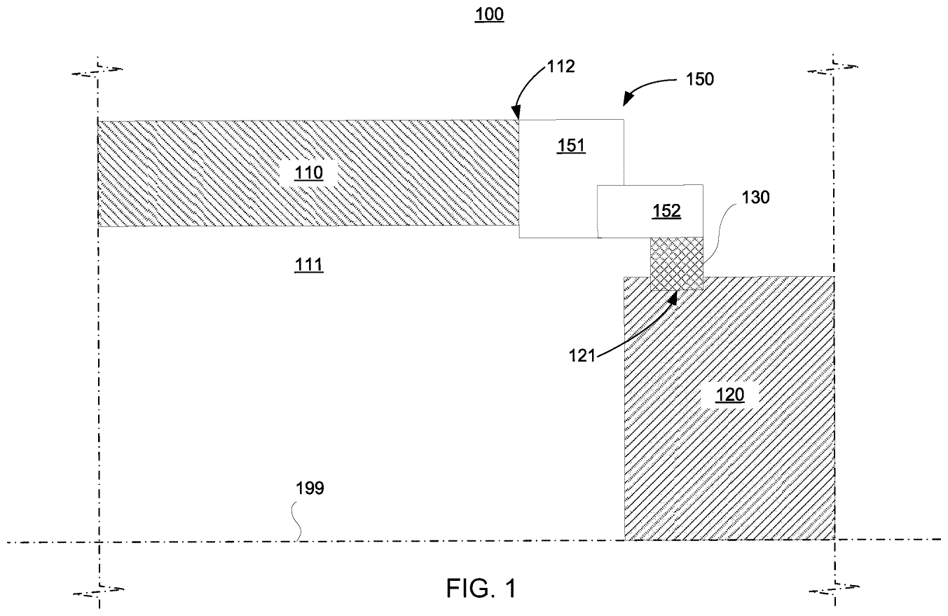

FIG. 1 shows a cross-sectional side view of an illustrative piston-cylinder assembly 100, with a tool installed (e.g., tool 150), in accordance with some embodiments of the present disclosure. Sealing ring assembly 130 is arranged in groove 121 of piston 120, as illustrated. In some embodiments, tool 150 is configured to interface to cylinder 110 at end 112. For example, when piston 120 is outboard of bore 111 of cylinder 110 (e.g., outboard of end 112, along center axis 199), sealing ring assembly 130 may also be positioned outboard of bore 111 (e.g., outboard of end 112). Sealing ring assembly 130 may include a plurality of segments that may seal against a land of piston 120, a feature of piston 120, bore 111, another segment, or a combination thereof. Because sealing ring assembly may include a plurality of segments, and each segment may be capable of moving (e.g., sliding, rotating, or a combination thereof), tool 150 may be installed to constrain displacement of the segments. To illustrate, when sealing ring assembly is outboard of end 112, bore 111 no longer provides a constraint on lateral (e.g., radial) displacement of the segments, and they may be susceptible to dropping (e.g., due to gravity or radial spring biasing of the ring segments), shifting, or otherwise becoming unwieldly during servicing. Tool 150 is configured to maintain the arrangement of the segments, or subsets thereof, to allow a controlled and repeatable technique to service sealing ring assembly 130.

Tool 150, as illustrated, includes element 151 and element 152. In some embodiments, element 151 is a body that interfaces to cylinder 110, and element 152 includes one or more retainers that constrain one or more segments of sealing ring assembly 130. For example, tool 150 may be arranged at end 112 of cylinder 110 (e.g., and affixed to cylinder 110), and piston 120 may be translated outboard past end 112, in any suitable order. Once outboard, element 152 (e.g., one or more retainers) constrains segments of sealing ring assembly 130 from falling (e.g., due to gravity) or otherwise shifting. In some embodiments, element 152 is movable (e.g., axially, radially, azimuthally) to remove the constraint on one or more segments of sealing ring assembly 130, allowing the one or more segments to be moved or removed (or conversely, installed). For example, element 152 may include a plurality of retainers arranged azimuthally around end 112 to constrain or release a plurality of ring segments as needed.

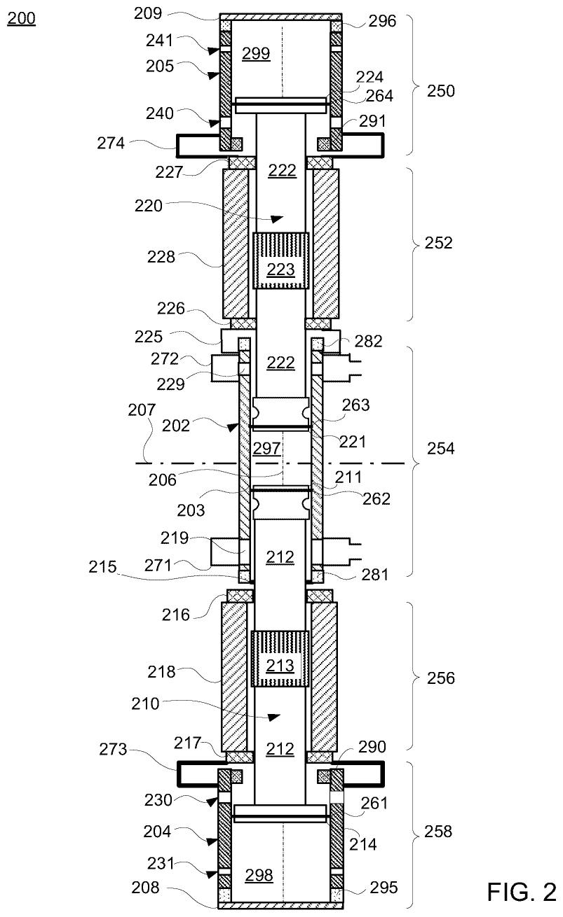

FIG. 2 shows a cross-sectional view of illustrative generator assembly 200, in accordance with some embodiments of the present disclosure. For example, generator assembly 200 may include a plurality of piston-cylinder assemblies, which may be similar to those of FIG. 1.

Accordingly, a tool such as tool 150 of FIG. 1 may be used to service any suitable seal (e.g., sealing ring assembly) of generator assembly 200. To illustrate, a tool (e.g., such as tool 150) may be configured to assist servicing any or all of seals 261, 262, 263, and 264.

Generator assembly 200 is configured as an opposed, generator. Generator assembly 200 includes translators 210 and 220, which are configured to move along axis 206 (e.g., translate linearly along axis 206). Translators 210 and 220 are configured to move within cylinders 202, 204 and 205, thus forming expansion and compression volumes (e.g., reaction section 297, gas spring 298, and gas spring 299) for performing boundary work (e.g., determined using the cyclic integral of PdV over a suitable range such as a stroke or cycle). For clarity, the spatial arrangement of the systems and assemblies described herein will generally be referred to in the context of cylindrical coordinates, having axial, radial, and azimuthal directions. It will be understood that any suitable coordinate system may be used (e.g., cylindrical coordinates may be mapped to any suitable coordinate system), in accordance with the present disclosure. Note that axis 206 is directed in the axial direction, and the radial direction is defined as being perpendicular to axis 206 (e.g., directed away from axis 206). The azimuthal direction is defined as the angular direction around axis 206 (e.g., orthogonal to both axis 206 and the radial direction, and directed around axis 206).

In some embodiments, the stationary components of generator assembly 200 include cylinder 202, cylinder 204, cylinder 205, stator 218, stator 228, bearing housing 216, bearing housing 217, bearing housing 226, bearing housing 227, seal 215, seal 225, exhaust manifold 271, and intake manifold 272. In some embodiments, bearing housings 216 and 217 are coupled to stator 218 (e.g., either directly connected, or coupled by an intermediate component such as a flexure or mount). For example, bearing housings 216 and 217 may be aligned to (e.g., laterally or axially aligned), and fastened to, stator 218 to maintain a radial air gap between magnet assembly 213 and stator 218. Similarly, in some embodiments, bearing housings 226 and 227 are rigidly coupled to stator 228.

Translator 210 includes tube 212, piston 211, seal 262 (e.g., a sealing ring assembly), piston 214, seal 261, and magnet assembly 213, all substantially rigidly coupled to move as a substantially rigid body along axis 206, relative to the stationary components. Translator 220 includes tube 222, piston 221, seal 263 (e.g., a sealing ring assembly), piston 224, seal 264, and magnet assembly 223, all substantially rigidly coupled to move as a substantially rigid body along axis 206. In some embodiments, pistons 211 and 221 may include features or components to manage, modify, reduce, or otherwise control thermal expansion of or heat transfer to tubes 212 and 222, respectively (e.g., a spacer with low thermal conductivity, a collar that affects the flow of blow-by gases, or both) In some embodiments, magnet assemblies 213 and 223 may be a region of tubes 212 and 222, respectively. In some embodiments, magnet assemblies 213 and 223 may include separate components affixed to tubes 212 and 222, respectively. Reaction section 297 is bounded by pistons 211 and 221 (e.g., and also defined by seals 262 and 263), as well as bore 203 of cylinder 202. Gas springs 298 and 299 are bounded by respective pistons 214 and 224, as well as respective cylinders 204 and 205. Accordingly, as translators 210 and 220 move along axis 206, the volumes of reaction section 297, gas spring 298, and gas spring 299 expand and contract. Further, for example, pressures within those volumes decrease or increase as the volume increases or decreases, respectively. Each of bearing housings 216, 217, 226, and 227 is configured to provide a gas bearing between itself and the corresponding translator (e.g., tube 212 and 222). For example, each of bearing housings 216, 217, 226, and 227 may be configured to direct pressurized gas to the gas bearing (e.g., via a flow system). In an illustrative example, each of bearing housings 216, 217, 226, and 227 may be configured to direct pressurized gas having an absolute pressure greater than ambient pressure (e.g., 1 atm at sea level) to the gas bearing such that bearing gas has sufficient pressure to flow through the gas bearing and into the environment (e.g., directly or via other ducting). In some embodiments, bearing gas may be pressurized relative to the environment (e.g., about 1 atm), a pressure in a breathing system (e.g., a boost pressure, or a gas pressure in an exhaust system that may be greater than or less than 1 atm), or any other suitable pressure reference. In some embodiments, generator assembly 200 is configured for oil-less operation, with bearing housings 216, 217, 226, and 227 forming gas bearings against translators 210 and 220. Each of translators 210 and 220 is configured to achieve a position-velocity trajectory. The trajectory may include a top dead center (TDC) position, when the respective translator is nearest axial centerline 207 (i.e., more inboard), and a bottom dead center (BDC) position, where the respective translator is furthest from axial centerline 207 (i.e., more outboard).

Cylinder 202 includes bore 203, which houses reaction section 297. Cylinder 202 also includes illustrative intake breathing ports 229 and exhaust breathing ports 219, which couple bore 203 to the outside of cylinder 202. For example, intake breathing ports 229 couple bore 203 to an intake system, such as intake manifold 272 thereof. In a further example, exhaust breathing ports 219 couple bore 203 to an exhaust system, such as exhaust manifold 271 thereof. Intake manifold 272 may seal to cylinder 202, seal 225 (e.g., by extending axially to seal 225), bearing housing 226 (e.g., by extending axially to bearing housing 226, an intervening component, or a combination thereof. Exhaust manifold 271 may seal to cylinder 202, seal 215, bearing housing 216 (e.g., by extending axially to bearing housing 216, an intervening component, or a combination thereof. In some embodiments, as illustrated, seal 215 includes a contact seal, which may be comprised of a self-lubricating material (e.g., graphite), ceramic material, metal, plastic, or any other suitable material, or any combination thereof. Seal 215 is stationary with respect to the motion of translator 210 and can be housed within a ring compressor 281 (as illustrated), cylinder 202, a dedicated seal holder, or any other suitable component, or any combination thereof. In some embodiments, seal 215 includes a contact seal, non-contact seal, any other suitable seal, or any combination thereof. In some embodiments, as illustrated, a translator cooler may be included to provide a flow of pressurized gas used to cool translator 210. When intake breathing ports 229 are not covered by piston 221 (e.g., intake ports are open), fluid exchange between reaction section 297 and the intake system may occur. When exhaust breathing ports 219 are not covered by piston 211, fluid exchange between reaction section 297 and the exhaust system may occur. Fluid flow primarily occurs from the intake system through intake breathing ports 229 to bore 203, and from bore 203 through exhaust breathing ports 219 to the exhaust system. For example, averaged over time, fluid flows from the intake system to bore 203, and from bore 203 to the exhaust system. However, flow may also occur in the opposite directions such as, for example, from blowback or plugging pulses, during some time periods (e.g., intermittent or transient events). In some embodiments, the radially outer surface of cylinder 202 is cooled. For example, the radially outer surface of cylinder 202 may be air-cooled (e.g., by a cooling system), liquid-cooled (e.g., by a cooling system), or both. In some embodiments, a thermal interface material may be arranged between the air cooling features (such as fins) and cylinder 202 to improve thermal conductivity. In some embodiments, cylinder 202 may include one or more ports arranged in between intake breathing ports 229 and exhaust breathing ports 219, which may be configured to house sensors (e.g., coupled to a control system), fuel injectors (e.g., coupled to an intake system or dedicated fuel system), or any other suitable components that may require access to bore 203. Along axis 206, intake breathing ports 229 and exhaust breathing ports 219 may be, but need not be, positioned symmetrically about a center of cylinder 202. Port location can be referenced to any suitable datum, however, one datum is the position of the front of the port (e.g., nearest axial centerline 207). The front of the ports defines the closed portion of the cycle (e.g., the start of compression, the end of expansion, the start of breathing, the end of breathing). For example, in some embodiments, exhaust breathing ports 219 may be relatively closer to axial centerline 207 than intake breathing ports 229. To illustrate, exhaust breathing ports 219 may open to reaction section 297 before intake breathing ports 229 during an expansion stroke, and exhaust breathing ports 219 may close to reaction section 297 after intake breathing ports 229 during a compression stroke. In some embodiments, breathing techniques other than uniflow scavenging may be used, such as, for example, loop scavenging or cross scavenging, and accordingly breathing ports may be positioned to be uncovered by only a single piston (e.g., with intake and exhaust breathing ports on the same side axially of the cylinder). In some embodiments, the centerline of piston positions may be changed during operation to change the relative timing of port openings and closings. For example, while the port locations may be spatially fixed on cylinder 202, the apex positions of pistons 211 and 221 (e.g., TDC position and BDC position) may be selected to move the TDC centerline (e.g., the midpoint between TDC positions of pistons 211 and 221 in either axial direction). In a further example, moving the TDC centerline may allow breathing behavior to be changed. The timing of port opening and closing, relative strength (e.g., amplitude in pressure wave), or both, of breathing behavior may be changed accordingly. Further, the compression ratio, expansion ratio, or both, may be changed by moving the TDC centerline or the BDC positions. To illustrate, the TDC centerline may, but need not, coincide axially with axial centerline 207. Breathing port locations and piston apex positions may be used to affect breathing behavior. In some embodiments, the BDC position of one or both pistons may be changed during operation to change the relative timing of port openings and closings. For example, one port may be maintained open longer to impact breathing. It will be understood that TDC and BDC refer to respective positions of pistons in contact with a reaction section (e.g., which correspond to BDC an TDC of pistons in contact with gas springs, respectively). For example, at or near TDC, a reaction section has a minimum volume and a gas spring has a maximum volume. In a further example at or near BDC, a reaction section has a maximum volume and a gas spring has a minimum volume. In some embodiments, cylinder assembly 254 includes cylinder 202, intake manifold 272, exhaust manifold 271, mounting hardware (e.g., mounts, flexures, or other hardware), and any other suitable components that may be mounted as a unit. Ring compressors 281 and 282 are coupled to the axial ends of cylinder 202 for the purposes of maintaining seals 262 and 263, respectively, within pistons 211 and 221, respectively, during replacement, installation, removal, or inspection. For example, during inspection or maintenance, translators 210 and 220 may be positioned axially so that ring compressors 281 and 282 are axially aligned with respective seals 262 and 263. Further, ring compressors 281 and 282 may be removed with respective pistons 211 and 221 during maintenance or inspection. Ring compressors 281 and 282 may have the same or similar inner diameter as bore 203 of cylinder 202. In some embodiments, ring compressors 281 and 282 may comprise of two or more sections (e.g., a clamshell design) configured to hold seals 262 and 263 in place during replacement, installation, removal, or inspection. In some embodiments, ring compressors 281 and 282 may comprise a single piece configured to hold seals 262 and 263 during replacement, installation, removal, or inspection. Ring compressors 281 and 282 may be attached to cylinder 202 through any suitable means, including but not limited to, v-band clamps, fasteners, bolts, springs, or any combination thereof. In some embodiments, tools such as tool 150 may be configured to replace, interface with, or interface to ring compressors 281 and 282 during servicing.

In some embodiments, as illustrated, cylinders 204 and 205 are closed by respective heads 208 and 209, which may be bolted or otherwise fastened to cylinders 204 and 205 (e.g., to suitable flanges of cylinders 204 and 205). In some embodiments, cylinders 204 and 205 include a closed end (e.g., to seal gas springs 298 and 299, respectively), and no separate head need be included. In some embodiments, as illustrated, spacers 295 and 296 are arranged to provide axial space, and hence volume, to respective gas springs 298 and 299. Spacers 295 and 296 may be bolted, fastened, or otherwise secured to respective cylinders 204 and 205, respective heads 208 and 209, or both. In some embodiments, spacers 295 and 296 are configured to function as ring compressors (e.g., during disassembly, inspection or replacement of rings). In some embodiments, spacers 295 and 296 may comprise two or more sections (e.g., a clamshell design). Cylinders 204 and 205 include respective lower-pressure ports 230 and 240 for exchanging lower pressure gas (e.g., for exchanging lower pressure gas) and respective higher-pressure ports 231 and 241 for exchanging higher pressure gas (e.g., for exchanging higher pressure gas). In some embodiments, lower-pressure ports 230 and 240 are coupled to the environment, with the corresponding gas flow referred to herein as “atmospheric breathing.” In some embodiments, lower-pressure ports 230 and 240 are coupled to a low-pressure reservoir or source (e.g., conditioned atmospheric air or other suitable gas reservoir or source above atmospheric pressure). For example, lower-pressure ports 230 and 240 may be coupled to respective reservoirs 273 and 274, as illustrated. Reservoirs 273 and 274 may be configured to seal back sections of pistons 214 and 224, respectively. As illustrated, reservoirs 273 and 274 are sealed against bearing housings 217 and 227, respectively, and also cylinders 204 and 205, respectively. Reservoirs 273 and 274 may be sealed against any suitable component of a linear generator including, for example, a frame, a stator, a gas spring head, any other suitable component, or any combination thereof. The volume of reservoirs 273 and 274 may be sized to minimize or otherwise limit pressure fluctuations in gas in the respective back sections. In some embodiments, a filter may be installed at, or upstream of, lower-pressure ports 230 and 240 to prevent the intake of particles (e.g., dust or debris), certain molecules (e.g., water in some instances), or other undesirable constituents of the gas source. In some embodiments, cylinders 204 and 205 need not include lower-pressure ports 230 and 240, higher-pressure ports 231 and 241, or any ports at all. For example, in some embodiments, no high-pressure ports are included, and lower-pressure ports 230 and 240 are included to provide make-up gas to make up for blow-by past respective pistons 214 and 224 (e.g., and may be included at any suitable location in the corresponding cylinder or cylinder head if applicable). In some embodiments, driver sections 250 and 258 may include features for removing energy from the generator system to protect against damage or failures (e.g., overpressure of gas spring 298 or 299, loss of sealing of gas spring 298 or 299). For example, either or both of cylinders 204 and 205 may include grooves (e.g., “scallops”) configured to allow higher-pressure gas to leak around the seals (e.g., rings) if pistons 214 and 224 overtravel, thus causing the gas spring to lose pressure and energy. In a further example, a pressure relief valve may be included and coupled to the gas spring to cause the gas spring to release energy (e.g., gas) if the pressure exceeds a design threshold.

Stator 218, magnet assembly 213, tube 212, and bearing housings 216 and 217 form linear electromagnetic machine (LEM) 256. Similarly, stator 228, magnet assembly 223, tube 222, and bearing housings 226 and 228 form LEM 252. Further, a LEM may optionally include one or more pistons. For example, a LEM may be defined to include stator 218, translator 210, and bearing housings 216 and 217. In a further example, a LEM may be defined to include stator 228, translator 220, and bearing housings 226 and 227. A LEM includes a stationary assembly (e.g., a stator and bearing housings) and a translating assembly (e.g., a translator) that is constrained to move along an axis, wherein the stator is capable of applying an electromagnetic force on the translator to cause and/or effect motion along the axis. The bearing housings of a LEM may be, but need not be, affixed to the stator. For example, the bearings housings may be coupled to the stator, a structural frame, a cylinder, either directly or by an intervening components, or any combination thereof. Stators 218 and 228 may include a plurality of phase windings, which form a plurality of phases. The current in each of the phases may be controlled in time by a control system (e.g., which may include corresponding power electronics and processing equipment) to affect the position of translators 210 and 220, motion of translators 210 and 220, work interactions with translators 210 and 220, or any combination thereof. In some embodiments, magnet assemblies 213 and 223 include permanent magnets arranged in an array (e.g., of alternating North and South poles). Because translators 210 and 220 move as substantially rigid assemblies, electromagnetic forces applied to respective magnet assemblies 213 and 223 accelerate and decelerate translators 210 and 220. In some embodiments, stators 218 and 228 may be air-cooled (e.g., by an air cooling system), liquid-cooled (e.g., by a liquid cooling system), or both. In some embodiments, stators 218 and 228 are arranged around respective translators 210 and 220, or respective magnet assemblies 213 and 223 thereof (e.g., the motor air gap is arcuate with a thickness profile). For example, stators 218 and 228 may extend fully around (e.g., 360 degrees azimuthally around) or partially around (e.g., having azimuthally arranged segments and azimuthally arranged gaps between windings of a phase) respective translators 210 and 220. In some embodiments, stators 218 and 228 are arranged axially along respective translators 210 and 220, or respective magnet assemblies 213 and 223 thereof. For example, magnet assemblies 213 and 223 may include flat magnet sections and stators 218 and 228 may include flat surfaces that correspond to the magnet sections (e.g., the motor air gap is planar with a thickness profile). In some embodiments, stators 218 and 228 extend axially along respective translators 210 and 220, or respective magnet assemblies 213 and 223 thereof.

In some embodiments, generator assembly 200 includes one or more features for protecting components of generator assembly 200 from damage due to mechanical failures, control failures, component failures, operation at extreme conditions, or a combination thereof. Bumpstops 290 and 291, as illustrated, are arranged to convert kinetic energy from respective translators 210 and 220 into deformation, by contacting respective pistons 214 and 224 in the event of an overtravel of the translators. For example, one or both of stators 218 and 228 may include one or more features for protecting generator assembly 200. In some embodiments, one or both of stators 218 and 228 include one or more features (e.g., a bumpstop, mechanical springs, pneumatic pistons) configured to convert translator kinetic energy into sound, heat, solid deformation, or a combination thereof, thus slowing, stopping, or redirecting the translator's motion. For example, a bumpstop may be configured to undergo a plastic deformation (e.g., be bent, compacted, crumpled, punched or otherwise deformed) upon contact with a translator to convert kinetic energy of the translator. In some embodiments, one or more bumpstops may be arranged at either or both of driver sections 250 and 258. In some embodiments, bumpstops are included as part of other components of generator assembly 200 such as, for example, driver sections 250 and 258. In some embodiments, bumpstops are located at each end of cylinder 202 near BDC. A bumpstop may be affixed directly or with intervening components to a structural frame at any suitable location, affixed directly or with intervening components to a cylinder at any suitable location (e.g., cylinder 202, 204, 205, or a combination thereof), affixed directly or with intervening components to a stator, or a combination thereof. In some embodiments, generator assembly 200 may include features or components for affixing to a structure frame.

For example, cylinder assembly 254, driver sections250 and 258, and LEMs 252 and 256 may include one or more features or components for affixing to a structural frame, one or more features or components for aligning to a structural frame, one or more components or features for aligning off of a structural frame to another component (e.g., LEM 252 to LEM 256, cylinder assembly 254 to a LEM), or any combination thereof. In some embodiments, features or components used to affix a portion of generator assembly 200 to a structural frame may provide compliance in a direction (e.g., axially, laterally, or radially) and stiffness in a different direction (e.g., axially stiff while radially compliant) to allow for changes during operation.

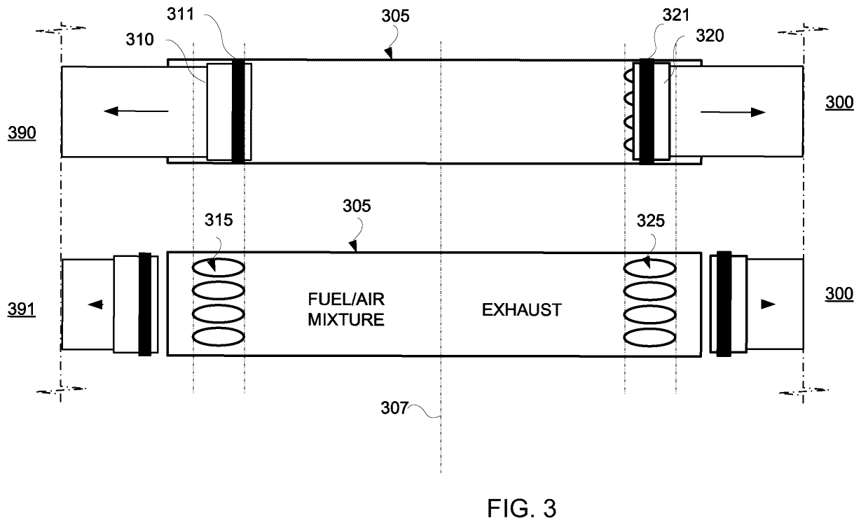

FIG. 3 shows a portion of an illustrative generator assembly 300, with intake pistons 310 and 320 at two respective axial positions, in accordance with some embodiments of the present disclosure. To illustrate, a tool (e.g., such as tool 150 of FIG. 1) may be configured to assist servicing any or all of seals 311 and 321. Intake piston 310 and exhaust piston 320 move within a bore of cylinder 305, along a center axis. The axial positions of intake and exhaust pistons 310 and 320 may be referenced to any suitable datum including, for example, an axial centerline.

Intake ports 315 and exhaust ports 325 are arranged axially at respective positions of cylinder 305. The axial positions of intake ports 315 and exhaust ports 325 may be, but need not be, equidistant from the axial centerline (e.g., line 307). For example, as illustrated, exhaust ports 325 are nearer the axial centerline (e.g., line 307) than intake ports 315. Panel 390 shows an illustrative start of breathing, with intake piston 310, having seal 311, axially positioned inboard of intake ports 315 (e.g., intake ports 315 are just opened to the reaction volume of cylinder 305). Panel 391 shows exhaust piston 320, having seal 321, axially positioned just within the axial extent of exhaust ports 325 (e.g., exhaust ports 425 are partially opened to the reaction volume of cylinder 305). Panel 391 shows intake piston 310, having seal 311, axially positioned outboard of cylinder 305. Panel 391 also shows exhaust piston 320, having seal 321, axially positioned outboard of cylinder 305.

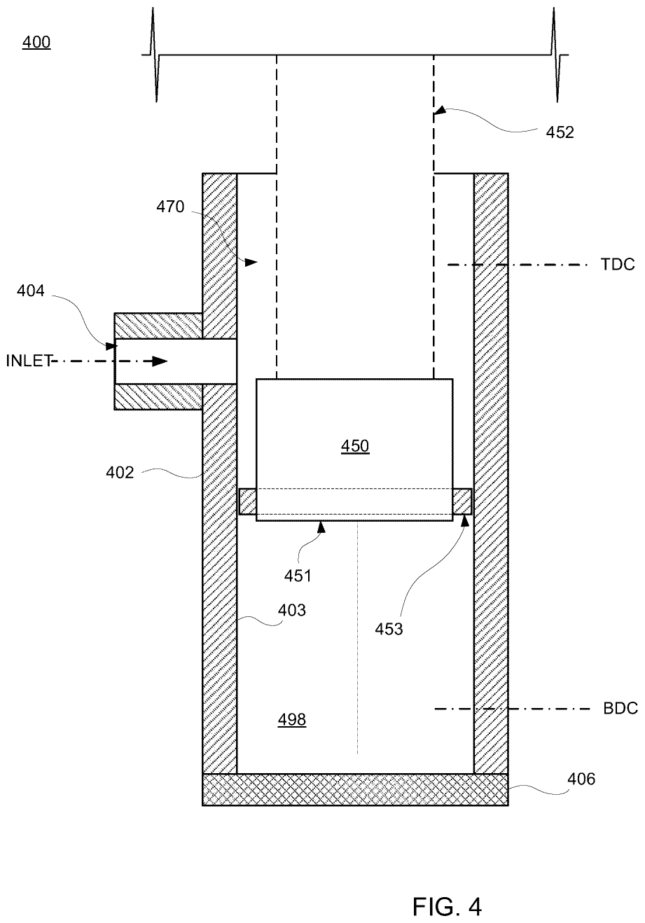

FIG. 4 shows a cross-sectional view of illustrative gas spring system 400, including a sealing ring assembly (e.g., seal 453), in accordance with some embodiments of the present disclosure. To illustrate, a tool (e.g., such as tool 150 of FIG. 1) may be configured to assist servicing of seal 453. Gas spring system 400 includes gas spring cylinder 402 having bore 403, piston 450 (e.g., part of translator 452), lower-pressure port 404, and cylinder head 406. In some embodiments, gas spring 498 is the volume formed between piston face 451 and gas spring cylinder 402 and cylinder head 406. Seal 453 is configured to seal the gas between piston 450 and bore 403, although in some embodiments, seal 453 is not needed. In some embodiments, seal 453 includes a sealing ring assembly (e.g., formed from graphite, plastics, metals or other suitable materials and configured to wear against bore 403, oiled sealing rings, or any other suitable sealing rings). In some embodiments, seal 453 is configured for oil-less operation (e.g., sealing without the use of oil or liquid for lubrication). Gas spring 498 is configured to store and release energy during compression and expansion, respectively, as the gas pressure in gas spring 498 changes.

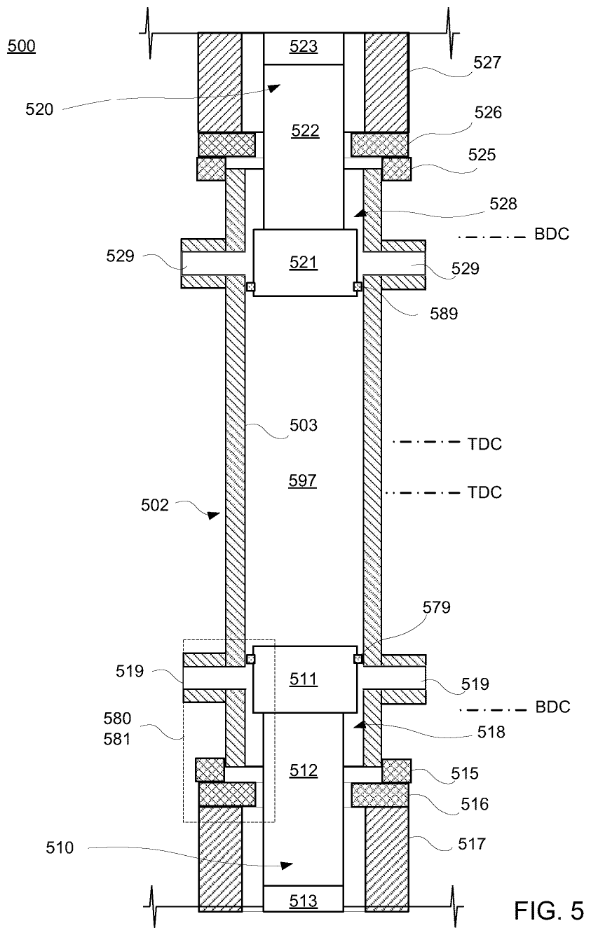

FIG. 5 shows a cross-sectional view of illustrative generator assembly portion 500, in accordance with some embodiments of the present disclosure. Generator assembly portion 500 includes a partial assembly of an integrated linear generator system, including cylinder 502 (e.g., a reaction cylinder), translators 510 and 520, stators 517 and 527, bearing housings 516 and 526, and seals 515 and 525. Translator 510 includes, for example, piston 511 with seal 579, tube 512, and section 513. Translator 520 includes, for example, piston 521 with seal 589, tube 522, and section 523. To illustrate, a tool (e.g., such as tool 150 of FIG. 1) may be configured to assist servicing of either or both of seals 579 and 589.

For discussion purposes, generator assembly portion 500 will be considered to use uniflow scavenging having intake ports and exhaust ports on opposite sides axially of cylinder 502, both without valves. Accordingly, for discussion purposes, translator 510 will be considered an intake-side translator because piston 511 covers and uncovers intake breathing ports 519. Further, for discussion purposes, translator 520 will be considered an exhaust-side translator because piston 521 covers and uncovers exhaust breathing ports 529. It will be understood that scavenging techniques other than uniflow scavenging may be used, in accordance with the present disclosure.

Seals 515 and 525 provide a seal between cylinder 502 and respective bearing housings 516 and 526. In some embodiments, seals 515 and 525 seal against cylinder 502 (e.g., on a radially outer surface, or an axially outer surface), and also against any suitable surface of respective bearing housings 516 and 526. For example, volumes 518 and 528, behind respective pistons 511 and 521 (e.g., away from reaction section 597) may include intake gas and exhaust, respectively. In some circumstances, it is not desirable for a reaction back section (e.g., volume 518) to be vented to atmosphere, because the intake gas therein may be at a boost pressure greater than atmospheric pressure causing the intake gas to flow out of bore 503 of cylinder 502 into the atmosphere (e.g., thus potentially venting fuel, if the intake gas is premixed, and, therefore, wasting energy). Similarly, in some circumstances, it is not desirable for a reaction back section (e.g., volume 528) to be vented to atmosphere, because the exhaust gas therein may be at an elevated temperature causing the performance of nearby components (e.g., such as stator 527 or other components) to be affected. Because bearing housings 516 and 526 provide pressurized gas to respective gas bearings, the corresponding bearing gas acts as a further seal, preventing gas from bore 503 of cylinder 502 or gas from volumes 518 and 528 from passing the corresponding gas bearing. For example, when the pressure of the intake gas bearing is larger than the pressure in the intake system or any pressure in volume 518, the intake gas is limited or prevented from leaking to the surroundings (e.g., atmosphere). Similarly, when the pressure of the exhaust gas bearing is larger than the pressure in the exhaust system or any pressure in volume 528, the exhaust gas in volume 528 is limited or prevented from leaking to the surroundings (e.g., atmosphere). Seals 515 and 525 may include, for example, O-rings, crush seals, gaskets, flanges, threads, alignment features, mating tolerances (e.g., a mating interface that is near gas-tight), any other suitable component or feature, or any combination thereof. Sections 580 and 581 provide enlarged views in FIGS. 36 and 37. In some embodiments, seal 515, seal 525, or both may be wholly or partially integrated into cylinder 502, respective bearing housings 516 and 526, or a combination thereof. For example, seals 515 and 525 need not include any rigid components or housing structures, and may include an O-ring or gasket between mating components. In some embodiments, seal 515, seal 525, or both may be configured to indirectly seal against cylinder 502. For example, a seal may seal against another component of the integrated linear generator system (e.g., an intake or exhaust manifold) that is sealed against cylinder 502. In some embodiments, generator assembly portion 500 may include one or more ring compressors, as illustrated in FIG. 2. For example, a respective ring compressor may be arranged at each axial end of cylinder 502, for interacting with respective seals 579 and 589. In some embodiments, a tool such as tool 150 of FIG. 1 may be configured to replace, interface with, or be integrated with a ring compressor.

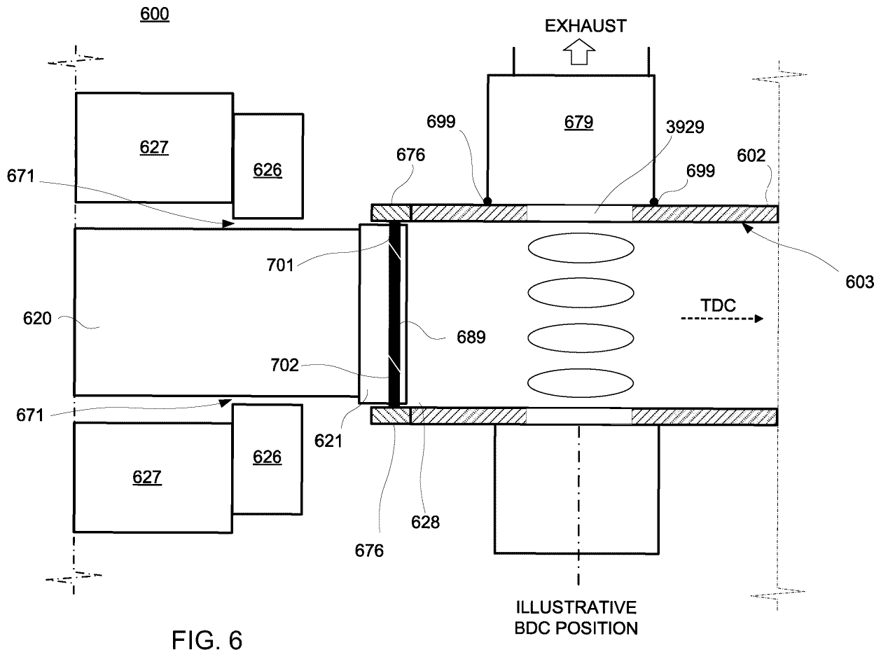

FIG. 6 shows a cross-sectional view of illustrative generator assembly portion 600, with seal 689 within ring compressor 676, in accordance with some embodiments of the present disclosure. In some embodiments, seal 689 may be removed in the configuration shown in FIG. 6 (e.g., during maintenance and inspection). Bearing gap 671 is arranged between bearing housing 626 (e.g., which may be mounted to stator 627) and translator 620 (i.e., the gas bearing) and may be purged with bearing gas (e.g., to keep the translator centered and allow axial motion). Seal 689 (e.g., a sealing ring assembly having segments including segments 701 and 702) seals piston 621 to bore 603 of cylinder 602 and is positioned outward of exhaust port 629 as illustrated in FIG. 6. Seal 699, as illustrated, seals between the outer surface of cylinder 602 and manifold 679.

Ring compressor 676 is a ring constraint configured to constrain seal 689 from rearrangement or disassembly during maintenance. For example, as illustrated, seal 689 is axially positioned within ring compressor 676 (e.g., during maintenance, inspection, installation, removal, replacement, or any other suitable activity occurring during other non-operation periods). As illustrated, seal 689 includes a multi-part seal that forms a sealing ring assembly (e.g., to accommodate wear of seal 689). In some exemplary embodiments, the ring compressor 676 includes a clam shell structure that can be opened to provide access to the seal 689. In other exemplary embodiments, the ring compressor 676 may comprise a single piece that may be moved axially out of the way to provide access to the seal 689.

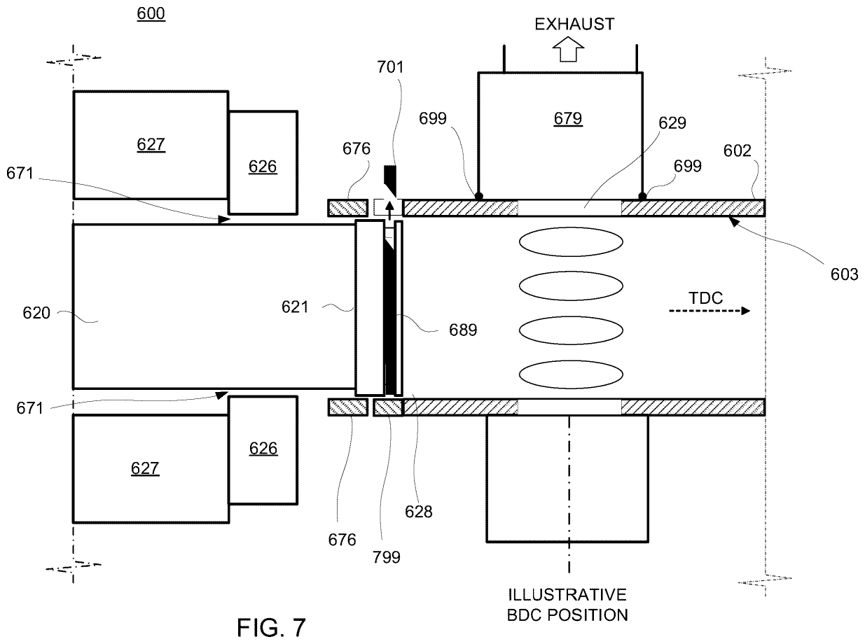

FIG. 7 shows a cross-sectional view of illustrative generator assembly portion 600 of FIG. 6, with ring compressor 676 removed axially outward from seal 689, in accordance with some embodiments of the present disclosure. As illustrated, with the ring compressor 676 moved radially outward and tool 799 is installed, seal 689 is partially disassembled, with segments removed from piston 621. Tool 799 may constrain some segments of seal 689 (e.g., segment 702), while others (e.g., segment 701) are not constrained and can be removed. For example, the configuration illustrated in FIG. 7 may correspond to a time during an inspection or replacement of seal 689, inspection of a land or ring groove of piston 621, or any other suitable time outside of operation of the generator assembly. In some embodiments, ring compressor 676 is configured to move radially outward, axially outward, or both, in order to remove ring segments. In some embodiments, tool 799 may replace ring compressor 676 during servicing, or alternatively ring compressor 676 need not be included at all.

In some embodiments, translator 620 may include one or more features (not shown) that may engage with corresponding features of a generator assembly to substantially lock translator 620 in place (e.g., axially, radially, azimuthally, or a combination thereof). For example, in the configuration of FIG. 7, translator 620 may be arranged at a suitable axial position of a generator assembly (e.g., relative to stator 627, bearing housing 626, cylinder 602, or a feature thereof), and locked in place. Translator 620 may include a feature (e.g., a blind hole, a through hole, a notch, a slot, a pin, a surface, any other suitable boss feature or recess feature, or any combination thereof), which may be engaged by a corresponding feature to prevent displacement of translator 620 in one or more directions. For example, translator 620 may include one or more blind holes, which are configured to engage with one or more pins that prevent axial motion of translator 620. In a further example, translator 620 may include one or more notches which are configured to engage with one or more pins that prevent axial motion of translator 620.

FIG. 8 shows a face view of illustrative sealing ring assembly 800 and springs 891-894, in accordance with some embodiments of the present disclosure. For example, as illustrated, sealing ring assembly may include a plurality of segments 801-808, with segments 801, 803, 805, and 807 corresponding to a front ring, and segments 802, 804, 806, and 808 corresponding to a rear ring. Springs 891-894 may apply a radially outward force on segments 801-808, directly or indirectly (e.g., applying a force to a first segment that transmit at least some of the force to another segment). In some embodiments, a sealing ring assembly includes graphite segments (e.g., eight segments 801-808 as illustrated) that may be mounted in a groove of a piston. To ensure proper sealing against a bore, in some embodiments, segments 801-808 are maintained radially outward by cantilever beam springs (e.g., a radial preload applied by springs 891-894). For example, the force may allow continuous contact between each segment and the bore. As sealing ring assembly 800 wears, it may be pushed outward (e.g., radially outward). In some embodiments, each of segments 801-808 overlaps the adjacent segments so there's a continuous seal between the piston and the cylinder. Once engaged inside the cylinder, the cylinder holds segments 801-808 together as they're pushed radially outward (e.g., to seal against the bore).

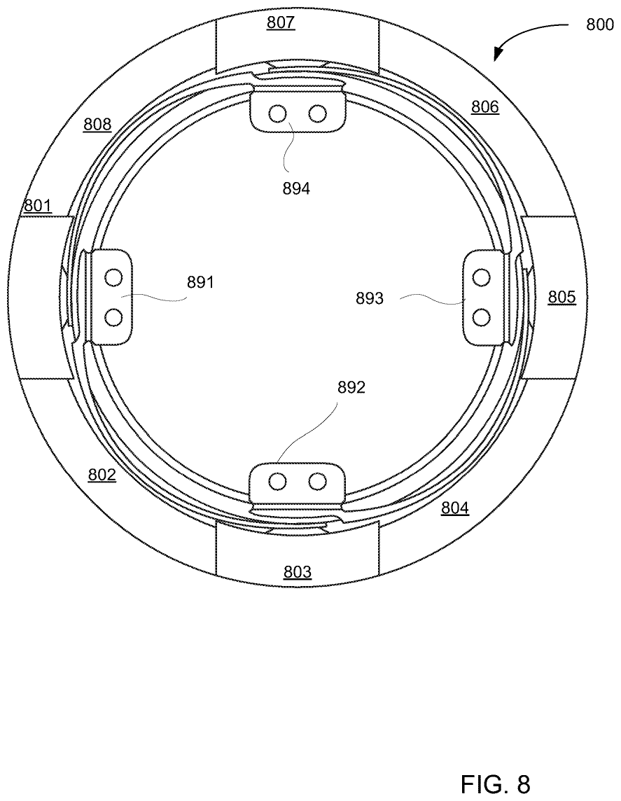

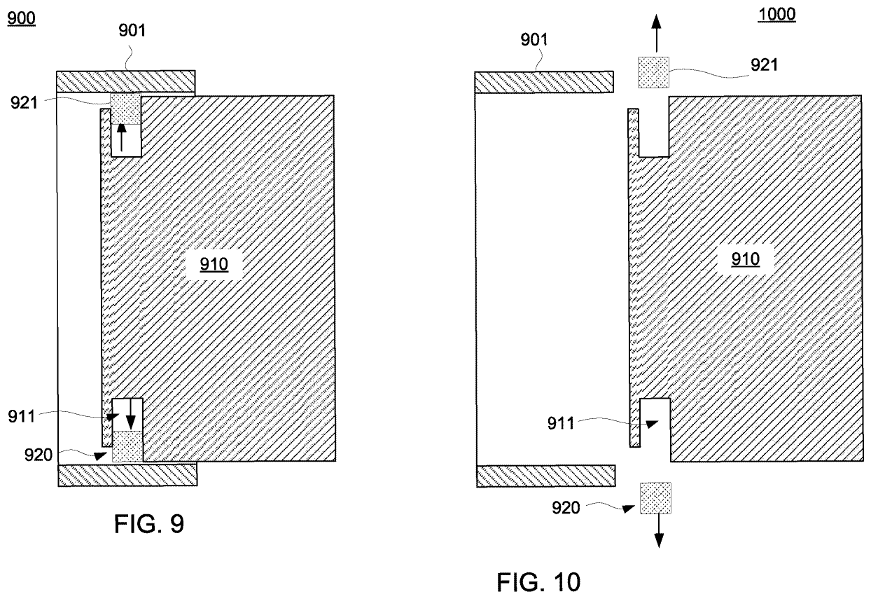

The radially outward force may affect servicing. For example, the piston may be moved out of the cylinder axially to create free access around a sealing ring assembly to install the segments (e.g., segments 801-808 of sealing ring assembly 800). In some embodiments, segments 801-808 are installed or removed in a particular order as they overlap each other in a special configuration to optimize the ring life duration, for example. An illustrative order may include, for example, 807, 805, 803, 801, 806, 804, 802, and 808 in sequence (e.g., front ring segments first and then rear ring segments). Following that order with each segment being pushed outward by springs 891-894, and nothing to retain them, segments 801-808 might naturally fall (e.g., due to gravity) when trying to install or remove them by hand (e.g., as illustrated in FIGS. 9-10). Installation and removal may be challenging and meticulous operations, depending upon the design and number of the segments.

FIGS. 9-10 shows two side cross-sectional views of an illustrative piston-cylinder interface, in accordance with some embodiments of the present disclosure. FIG. 9 illustrates configuration 900, wherein piston 910 includes groove 911 in which ring 920 is installed and radially bound by cylinder 901 (e.g., a bore thereof). A radially outward force may be imparted to ring 920, as indicated by the arrows in FIG. 9. For example, the force may be imparted by a spring force between segments or a spring force between one or more segments and the piston. As illustrated in FIG. 10, when piston 910, or otherwise groove 911, is axially outboard of an end of cylinder 901, segments of ring 920 (e.g., of which segment 921 is one) may move as indicated by the arrows.

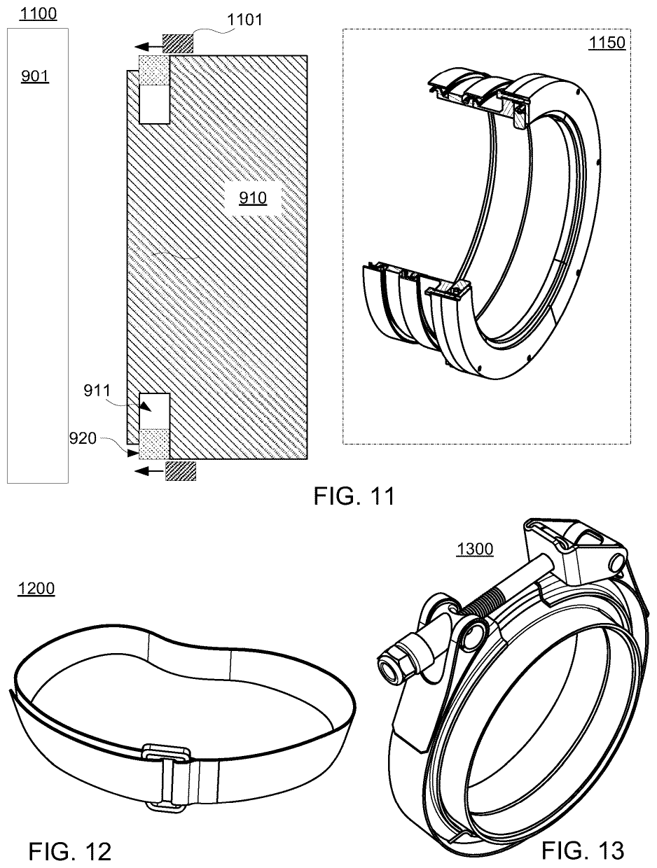

FIG. 11 shows a side cross-sectional views of the illustrative piston-cylinder interface of FIGS. 9-10, with tool 1101, in accordance with some embodiments of the present disclosure. To illustrate, tool 1101 may include a band, strap, collar, or any other suitable ring compressor or ring constraint (e.g., as illustrated in FIGS. 12-13). As illustrated, in configuration 1100, piston 910 is outboard of the end of cylinder 901, with tool 1101 being arranged into place to constrain the segments of ring 920. The axial arrows in FIG. 11 indicate that tool 1101 may be axially slid onto ring 920 (e.g., as ring 920 clear the end of cylinder 901 or when a ring compressor is removed). Because tool 1101 constrains the segments of ring 920, the chance that the segments fall or otherwise shift uncontrollably is significantly reduced or eliminated. Panel 1150 illustrates a perspective cross-sectional view of tool 1101, in accordance with some embodiments of the present disclosure.

FIG. 12 shows a perspective view of illustrative strap 1200 for maintaining ring configuration, in accordance with some embodiments of the present disclosure. Strap 1200 may include a flexible material (e.g., including Velcro) that may be mounted around a piston, axially offset from the ring insertion groove, and then may be fit around segments while sliding the band around it to hold them (e.g., as segments are inserted). Similarly, FIG. 13 shows a perspective view of illustrative band 1300 for maintain ring configuration, in accordance with some embodiments of the present disclosure. Band 1300 may include a stiffer material than strap 1200 such as, for example, a steel band (e.g., with a threaded fastener for tightening the band). In some circumstances, only a portion (e.g., one eighth) of strap 1200 or band 1300 may be fit at a time, and segments may be locked one at a time. This could lead to segments falling as installing the next segment and pushing the band away (e.g., radially outward or axially), so the installation technique may be modified as compared to multi-element tools (e.g., with retainers). In a further example, strap 1200 may be retightened to maintain the pressure and resist the segment force (e.g., radially outward).

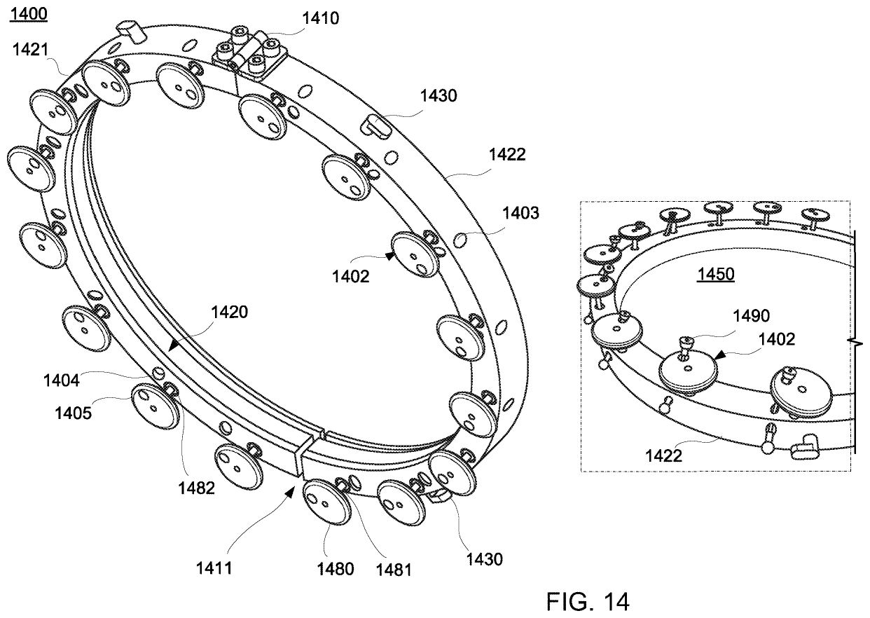

FIG. 14 shows a perspective view of illustrative tool 1400 having retainers 1402, in accordance with some embodiments of the present disclosure. As illustrated, tool 1400 includes body elements 1421 and 1422, which are coupled by hinge 1410 and form interface 1411 (e.g., to allow tool 1400 to be fit around and clamped onto a cylinder). Tool 1400 also includes retainers 1402 (e.g., a plurality of retainers) arranged azimuthally along body elements 1421 and 1422. Retainers 1402 may include head 1480 (e.g., a disc) and spine 1481 (e.g., a pin), which may be configured to move axially through corresponding holes in body elements 1421 and 1422 that accommodate the spines of the retainers. In some embodiments, each of retainers 1402 is axially biased by a spring (e.g., arranged in axial holes 1482).

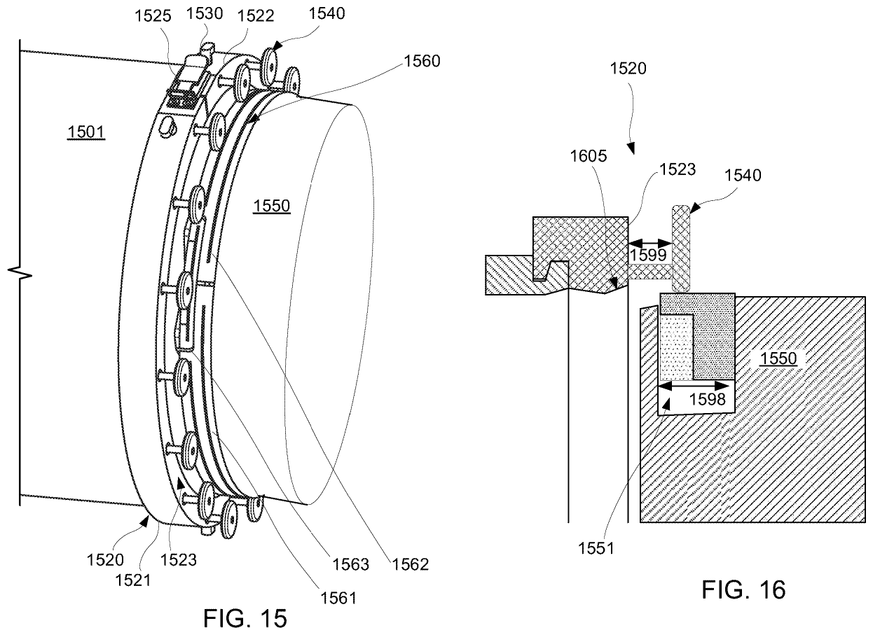

The present disclosure is directed to, in some embodiments, a ring change tool (e.g., tool 1400) made of two half rings (e.g., body elements 1421 and 1422, which may be first and second azimuthal segments) that are connected with a hinge (e.g., hinge 1410), and that can be closed to each other with a clamp at interface 1411 (the clamp is not shown in FIG. 14, but illustrated in FIG. 15, for example). A tool may include one or more than one azimuthal segments arranged around the ring to constrain the segments of the ring. In some embodiments, spring plunger pins (e.g., spines such as spine 1481) are permanently and equally inserted around the tool (e.g., in axial holes 1482), with a disc (e.g., heads such as head 1480) mated on the top of each pin. In some embodiments, holes 1403, 1404, and 1405 (e.g., axial holes) are included in tool 1400 to add a safety tether such as retaining wire in case a disc may come loose (e.g., preventing it from falling into the cylinder). In some embodiments, a retainer may include a stopper boss on one side to prevent the retainer from falling from the other side. In some embodiments, the two halves (e.g., body elements 1421 and 1422) form a ring configured to be closed around the end of a cylinder. In some embodiments, tool 1400 includes groove feature 1420 configured to clamp on the edge of the cylinder using a lip with a matching groove to secure it axially (e.g., see FIG. 16). Groove feature 1420 is an example of a mounting feature configured to affix the tool to the cylinder, piston, or both. In some embodiments, there may be a functional gap between the two halves of the tool at interface 1411, ensuring a constant tension from the clamp and avoiding play around the cylinder (e.g., azimuthal displacement). Further, in some embodiments, tool 1400 may include hook features 1430 on each side that allow mounting an elastic band instead of the latch or in case the latch or hinge fails (e.g., to impose a compressive force on tool 1400). Enlargement 1450 illustrates a perspective view of a portion of tool 1400 with tethers 1490 (e.g., which may include sections of retaining wire) installed to retain retainers such as retainer 1402 to element 1422. Each tether of a plurality of tethers may be configured to secure one respective retainer, for example.

FIG. 15 shows a perspective view of illustrative tool 1520 having retainers arranged at the end of cylinder 1501, in accordance with some embodiments of the present disclosure. FIG. 16 show a cross-sectional side view of illustrative tool 1520 and cylinder 1501 of FIG. 15, in accordance with some embodiments of the present disclosure. To illustrate, tool 1520 may be same as or similar to tool 1400 of FIG. 14. As illustrated, tool 1520 includes elements 1521 and 1522 (e.g., similar to body elements 1421 and 1422 of FIG. 14), retainers 1540 (e.g., similar to retainer 1402 of FIG. 14), and clasp 1530 to hold elements 1521 and 1522 together (e.g., and may include a hinge such as hinge 1410, not shown in FIG. 15). Similar to tool 1400, the retainers 1540 of tool 1520 may be spring loaded, so as to be biased axially outward with a spring. As illustrated, ring 1560 includes a plurality of segments including segments 1561, 1562, and 1563.

The use of tool 1520 may include clamping it on the edge (e.g., an axial end) of cylinder 1501 first, before piston 1550 is pulled out of cylinder 1501 (axially) in case of ring replacement (e.g., replacement of ring 1560). Using a translator pull tool to move the translator, a user can manually slide piston 1550 out of cylinder 1501, until the ring segments come in contact with the discs of the tool (e.g., retainers 1540). In some embodiments, the axial pulling of the translator may be automated using a stator and phase currents therein. In some embodiments, an axial gap (e.g., having distance 1599) between the surface of the tool (e.g., surface 1523 of element 1521) and the discs (e.g., a pin length of retainers 1540) is shorter than a thickness (e.g., thickness 1598) of the ring segments (e.g., including segments 1561-1563) to prevent the ring segments from popping out in between the tool and the discs (e.g., and getting stuck in the gap). In an illustrative example, in some embodiments, the inner diameter formed by the disc pattern (e.g., the inner circle defined by the radially inner points of retainers 1540) is D1 and the outer diameter of the ring is D2, which is greater than D1 (e.g., illustratively D1 may be 194 mm whereas D2 may be 195 mm). This configuration of D1 and D2 may help ensure tension is maintained on the segments and to compensate for play in the pins, for example.

Once tool 1520 is interfaced to cylinder 1501, one or more pins can be pressed to liberate and remove each segment from groove 1551 of piston 1550. For example, a user can remove each segment one by one, without the others moving or falling, allowing the user to record where the removed segment was installed for analysis (e.g., each segment may be indexed for location for wear analysis). In some embodiments, tool 1520 also allows a technician to remove segments using one hand, pressing the pin with a first hand and removing the segment with the other hand (e.g., leading to ease of use by a single person requiring low skill and lesser training). In some embodiments, tool 1520 may be used for single segment, or several segments (e.g., a plurality of segments) removal rather than the whole ring (e.g., all of the segments). To illustrate, segment 1563 may be removed by pressing two retainers (e.g., which azimuthally overlap segment 1563). Further, in this embodiments, more than two retainers must be pressed to remove either of segments 1561 or 1562. Accordingly, depending on the retainer size and spacing, and the segment size and positioning, the number of retainers which must be reconfigured may be one, two, or more than two retainers.

Once the segments are removed, the reverse operation may commence, including installing a new or replacement ring (e.g., or an initial first one in case of a new system being built), pressing the pins (e.g., towards cylinder 1501), sliding in the segment (e.g., to groove 1551 of piston 1550), and then releasing the pin such that is extends over the segment and keeps the segment in place in groove 1551. In some embodiments, tool 1520 includes a tapered edge (e.g., feature 1605 in FIG. 16) to ensure smoothness of piston insertion toward cylinder 1501 and into tool 1520 (e.g., axially) as ring 1560 starts making contact with it. After use (e.g., once ring 1560 is bound by cylinder 1501), tool 1520 can be removed and stored. To illustrate, tool 1520 may be custom for each system, cylinder, ring, or piston design, allowing removal of segments one by one for any suitable system, for both removal and installation.

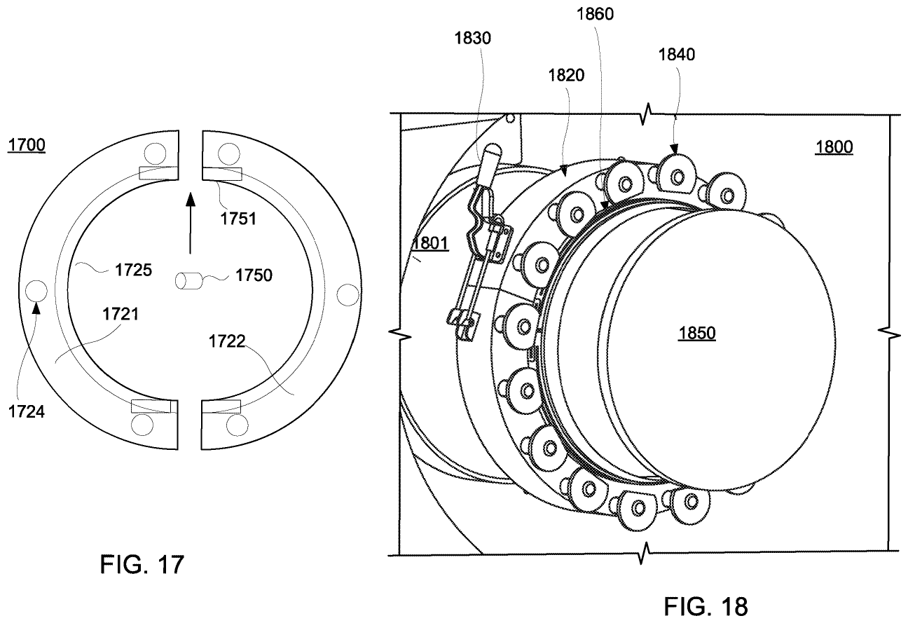

FIG. 17 shows a perspective view of illustrative tool 1700 having one or more magnets 1750, in accordance with some embodiments of the present disclosure. As illustrated, tool 1700 includes retainers (e.g., illustrated as pins 1724) arranged along a body (e.g., element 1721 and 1722). Tool 1700 also includes features 1725 for interfacing to a mating feature of a piston (e.g., to prevent clocking or otherwise slipping). Magnets 1750 (e.g., permanent magnets) may be used to affix elements 1721 and 1722 at their respective azimuthal ends. For example, each of elements 1721 and 1722 may include recesses 1751 configured to accommodate one of magnets 1750. Accordingly, when mating ends of elements 1721 and 1722 are put together, the resulting adjacent magnets may function to hold the body together.

In some embodiments, the initial mating between two halves of the tool (e.g., elements 1721 and 1722) is based on magnets (e.g., magnets 1750) holding them together. In some embodiments, the tool includes a hinge and clamp as illustrated in FIGS. 14-15 (e.g., having sufficient size, force, and robustness). In some embodiments, tool 1700 may be configured to grab or otherwise engage a piston rather than or in addition to a cylinder. For example, because of space constraints on certain areas to pull the cylinder outboard sufficiently, it may be desired to attach tool 1700 to a fixed part (e.g., the cylinder). In some embodiments, no disc or head need be included as part of a retainer, but rather only pins that would directly lock the segment themselves (e.g., pins 1724). Accordingly, a tool may include retainers of differing shapes, types, materials, freedom of movement, material, any other suitable property, or combination of properties.

FIG. 18 shows a perspective view of illustrative tool 1820 having contoured retainers 1840, in accordance with some embodiments of the present disclosure. As illustrated, tool 1820 is affixed to cylinder 1801 (e.g., using clamp 1830 and a hinge), with ring 1860 installed in a groove of piston 1850. Tool 1820 includes a plurality of retainers 1840, which are disc-shaped with a sector cutout (e.g., generally round but with a “flat”). Accordingly, depending on the rotational orientation of each retainer (e.g., each of retainers 1840 may be able rotate about an axis of the corresponding pin), the effective inner radial position of each retainer may be able to achieve more than one value (e.g., each retainer head includes a non-constant radius). In some such embodiments, each of retainers 1840 may be axially positioned, rotated, or both to retain or release each segment of ring 1860. In some embodiments, tool 1820 includes retainers 1840 having a round washer and a flat-sided washer to form a disc-like shape (e.g., the round washer may have a lesser diameter to maintain the flat), which may be rotated to liberate the segment as needed. In some embodiments, the thickness of the washer may be designed to prevent scrubbing the segment. In some embodiments, each retainer may be cam-shaped or otherwise have a non-constant diameter.

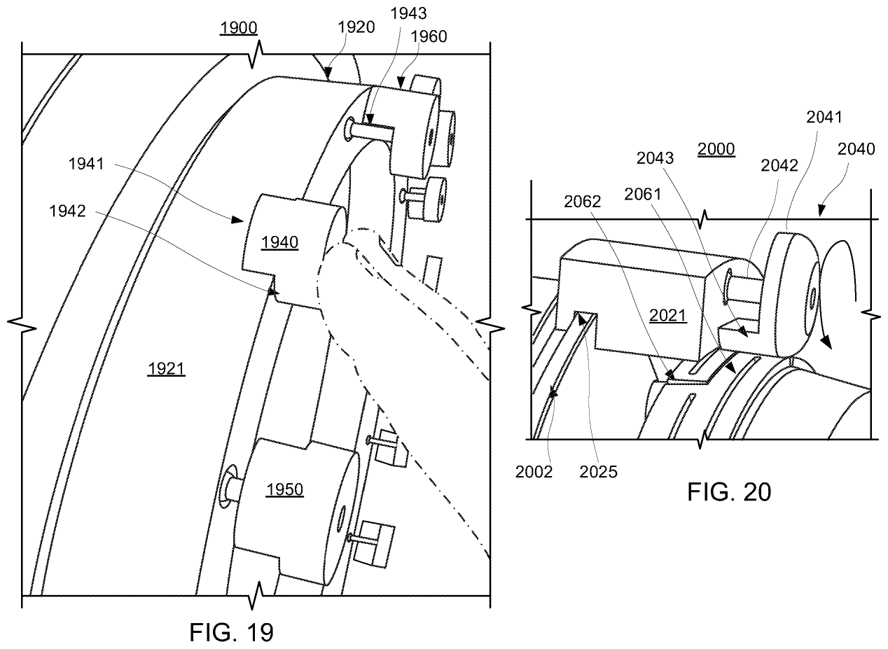

FIG. 19 shows a perspective view of illustrative tool 1900 having retainers (e.g., including retainers 1940, 1950, and 1960) with varying thicknesses, in accordance with some embodiments of the present disclosure. In some embodiments, retainers may include custom washers or heads having a thicker side (e.g., asymmetric washers). For example, retainers 1940, 1950, and 1960 may be rotated to allow either sliding or locking against body 1921. For example, as illustrated retainer 1960 (e.g., having pin 1943) is axially extended from body 1921, while retainer 1940 is axially retracted to body 1921. Retainer 1940, as illustrated, includes a head having two sections 1941 and 1942. Each of sections 1941 and 1942 has cylindrical bound, but section 1941 is only a sector of the cylinder. Accordingly, when retainer 1940 is rotated such that section 1941 is radially outward of body 1921 (e.g., a first angular orientation), retainer 1940 may be retracted axially against body 1921 or if extended, may exhibit a greater effected inner diameter (e.g., allowing a ring segment to move radially outward for removal or installation). Similarly, when retainer 1940 is rotated such that section 1941 is inward (e.g., a second angular orientation), and retainer 1940 is axially extended from body 1921, section 1941 may contact and constrain the ring segment.

FIG. 20 shows a perspective view of illustrative tool 2000 having rotatable retainers 2040, in accordance with some embodiments of the present disclosure. As illustrated, tool 2000 includes groove 2025 that interfaces with lip 2002 of the cylinder. Tool 2000 includes body 2021 and retainer 2040, which includes pin 2042 and head 2041. Head 2041, similar to retainer 1940 of FIG. 19, for example, includes section 2043 that may be rotated to constrain segments 2061 and 2062, or rotated and retracted against body 2021 to free segment 2061 (e.g., rotation is illustrated by the circular arrow in FIG. 20). To illustrate, when section 2043 is rotated to be radially outward (e.g., outward of body 2021), retainer 2040 may be moved radially towards body 2021 such that head 2041 is against body 2021 with section 2043 extending along an outer surface of body 2021 (e.g., as illustrated by the position of retainer 1940 in FIG. 19). The retainer may be biased by a radial spring force that is toward the body 2021 of the tool 2000 such that when section 2043 is rotated the retainer 2040 is pulled toward the body 2021 such that the head 2041 rests against the body 2021.

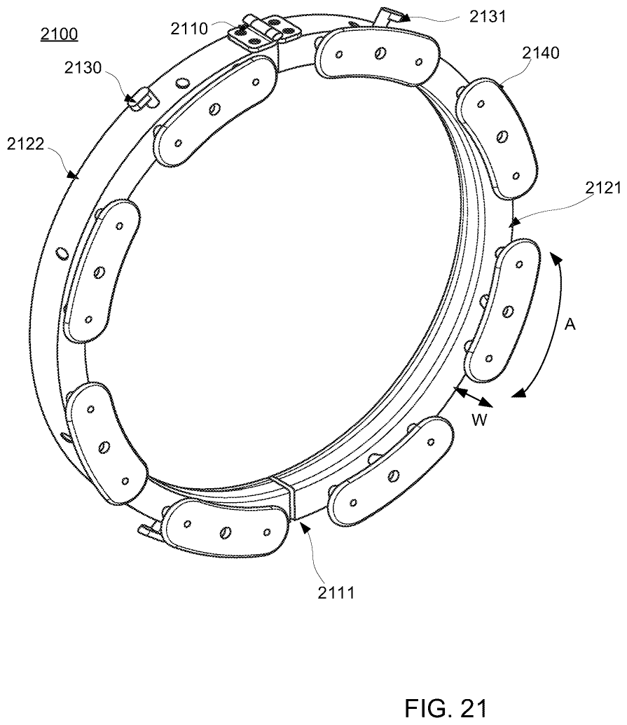

FIG. 21 shows a perspective view of illustrative tool 2100 having arc-shaped retainers 2120, in accordance with some embodiments of the present disclosure. As illustrated, tool 2100 includes elements 2121 and 2122, which are coupled by hinge 2110. Tool 2100 includes a plurality of retainers 2140, which each are arc-shaped having an azimuthal length A greater than a radial width W. Tool 2100 may also include features 2130 and 2131 (and corresponding features spanning interface 2111) to allow for an elastic band to be applied to hold elements 2121 and 2122 together (e.g., when installed). For example, the tool may include a double-disc system to result in a better (e.g., greater) contact surface with the segment and thus allow better position control and locking. In some such embodiments, the pin sliding motion (e.g., axial displacement) may be achieved using one, two, or more than two pins (e.g., although more pins may lead to the motion being over constrained). In some embodiments, tool 2100 may include suitable tolerances to ensure binding does not occur or is otherwise mitigated. For example, during travel or in circumstance of being too loose to effectively locate the ring segments, there may be a risk of too much displacement. In some embodiments, a tool may include an extended retainer the design equivalent to three, four, or more discs (e.g., the ratio A/W may be 3, 4, or more than 4).

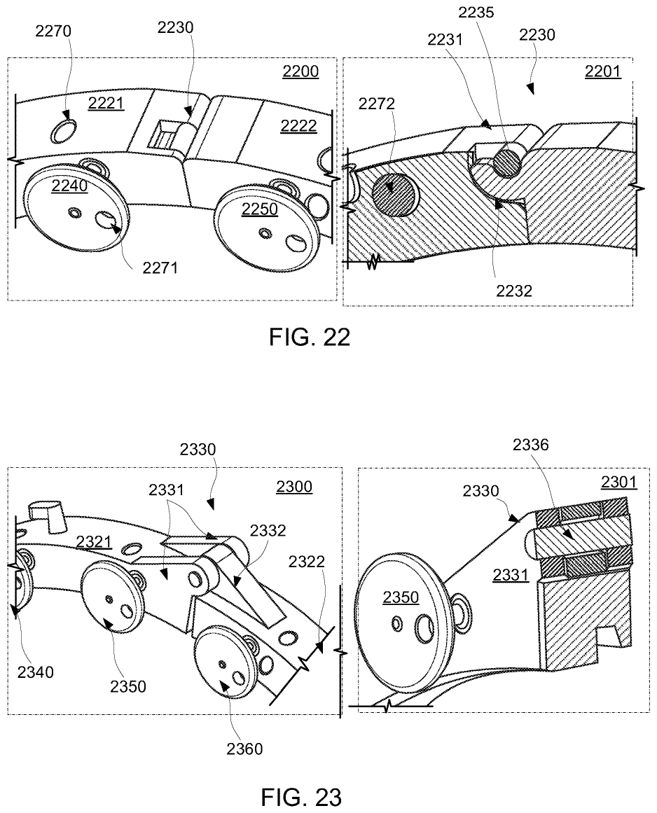

FIG. 22 show perspective views of a portion of an illustrative tool having hinge features, in accordance with some embodiments of the present disclosure. As illustrated in panels 2200 and 2201, the tool includes elements 2221 and 2222, joined by hinge features 2231 and 2232 to form hinge 2230. As illustrated, element 2221 includes hinge feature 2231 (e.g., including an extension and pin 2235), and element 2222 includes hinge feature 2232 (e.g., a hook to capture pin 2235). The tool also includes retainers 2240 and 2250 (among other retainers), with holes 2270, 2271, and 2272 for securing retainers with wire. In some embodiments, the discs of retainers 2240 and 2250 are adhered to respective pins using any suitable adhesive. In some embodiments, the discs of retainers 2240 and 2250 are fastened to respective pins using threads, press fits, or any other suitable mechanical fastener. In some embodiments, the discs of retainers 2240 and 2250 are made integral as a single molded or machined part with their respective pins. In some embodiments, the discs of retainers 2240 and 2250 are made out of metal such that they are welded to respective pins rather than bonded (e.g., epoxied). For example, in some embodiments, the tool need not include tethers such as a retaining wire, which might get in the way when using the tool (e.g., as it sticks out of the discs); instead, the pins may have a retaining feature such as a boss, flange, cotter pin, or flared end on the opposite side of the tool (i.e., elements 2221 and 2222) so that the disc/pin assembly is held captive on the side opposite the disc. In some embodiments, regarding a hinge, by removing it and incorporating it to the body sections of the tools (e.g., 3D printed halves such as elements 2221 and 2222), there may be a lessened risk of it being loose, breaking, or an element falling from it (e.g., such as a pin).

FIG. 23 shows perspective views of a portion of illustrative tool having a hinge pin, in accordance with some embodiments of the present disclosure. As illustrated in panels 2300 and 2301, the tool includes elements 2321 and 2322, joined by hinge features 2331 and 2332 with pin 2336 to form hinge 2330. As illustrated, element 2321 includes hinge feature 2331 (e.g., including extensions), and element 2322 includes hinge feature 2332 (e.g., an extension). Pin 2336 is configured to engage with holes of hinge features 2331 and 2332 to form a hinge joint. The tool also includes retainers 2340, 2350, and 2360 (among other retainers). In some embodiments, elements 2221 and 2222 may be molded, injection molded, or 3D-printed from a suitable material (e.g., soft metal, plastic).

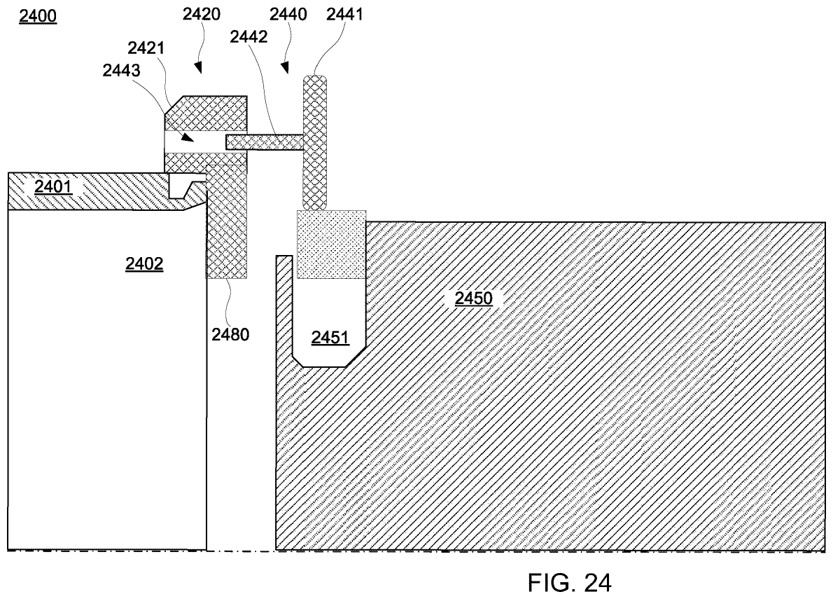

FIG. 24 shows a side cross sectional view of illustrative tool 2420 having flange 2280 and installed on cylinder 2401, in accordance with some embodiments of the present disclosure. As illustrated, ring 2460 is installed in groove 2451 of piston 2450 and retained by retainers 2440 of tool 2420. Tool 2420, as illustrated, includes body 2421 having recesses 2443 to accommodate pins 2442 of retainers 2440. Heads 2441 of retainers 2440 are in contact with segments of ring 2460, constraining radial displacement of the segments. To illustrate, if retainers 2440 are pressed axially (e.g., leftwards as illustrated in FIG. 24), segments of ring 2460 may be freed for removal, or be capable of being installed (e.g., during installation). Tool 2420 includes flange 2480 that extends radially in front of bore 2402 of cylinder 2401 such that piston face 2452 of piston 2450 cannot travel axially past flange 2480. For example, flange 2480 prevents piston 2450 from moving into bore 2402, which might lead to breakage of ring 2460 or safety concerns (e.g., a pinch point may be generated between piston 2450 and cylinder 2401).

Flange 2480 may be integrated as part of body 2421 or may be separate part (e.g., that is fastened, mounted, or adhered to body 2421 or cylinder 2401)

In some embodiments, flange 2480 may be a safety feature configured to protrude radially inward to at least partially block the cylinder entrance. For example, if piston 2450 were axially pushed inboard toward cylinder 2401, piston 2450 (or piston face 2452 thereof) would be blocked, thus protecting a technician from a pinch point. To illustrate, for example, flange 2480 may be included or otherwise used if the LEM is powered. For example, even if the translator is mechanically locked, it may experience electromagnetic forces toward cylinder 2401, and flange 2480 may provide a failsafe. However, because flange 2480 blocks bore 2402, piston 2450 might not be able to slide axially in cylinder 2401. Thus, flange 2480 might be omitted during sliding ring 2460 axially out of bore 2402, but rather to install ring 2460 around the static piston. In some circumstances, another device may be used to move piston 2450 in and out of the cylinder without losing the ring segments of ring 2460.

In some embodiments, the tool material (e.g., of tool 150, tool 1400, tool 1520, tool 1700, tool 1820, tool 1920, tool 2000, tool 2100, the tools of FIG. 22 or 23, or 2420) may be a metal such as steel or aluminum (e.g., for body elements, retainers, or components thereof) or a polymer, or a combination thereof. In some embodiments, the bonding between the pins and discs may include adhesive (e.g., epoxy may be used for plastic components, or a chemical glue or an ultrasonically welded joint).

In some embodiments, a tool (e.g., tool 150, tool 1400, tool 1520, tool 1700, tool 1820, tool 1920, tool 2000, tool 2100, the tools of FIG. 22 or 23, or 2420), cylinder, or both include a visual indicator, index, boss feature (e.g., extending outward from a surface, such as a pin), a recess feature (e.g., extending into a surface, such as a hole), any other suitable feature, or any combination thereof, which may be used to azimuthally clock and optionally retain the tool on the end of the cylinder. For example, one or more azimuthal regions of a ring change tool may be aligned to one or more ring segments to ensure the retainers align with appropriate portions of the ring segments. In a further example, in some embodiments, the ring change tool may be indexed, labeled, or otherwise configured to identify and differentiate each ring segment (e.g., for failure analysis, assembly, disassembly, indexing, wear measurements, etc.). In a further example, the tolerances may be reviewed and fine-tuned to better match the system, as there may be play between the pins, hinge, and tool itself (e.g., caused by 3D print accuracy or otherwise manufacturing accuracy). In some circumstances, contact between the disc and segment is critical (e.g., and may be desired to be very precise).

In some embodiments, mating between the metal pins and discs may be a consideration as a glue might not be strong enough and a disc may fail (e.g., be lost in a cylinder). In some embodiments, safety wire is added to retainers of a tool (e.g., of tool 150, tool 1400, tool 1520, tool 1700, tool 1820, tool 1920, tool 2000, tool 2100, the tools of FIG. 22 or 23, or 2420) to help retention and prevent disassembly (e.g., a component being free in the system). In some embodiments, welded metal disc may be used, or the disc and plunger shaft may be made of a contiguous piece that may be, for example, machined or molded.

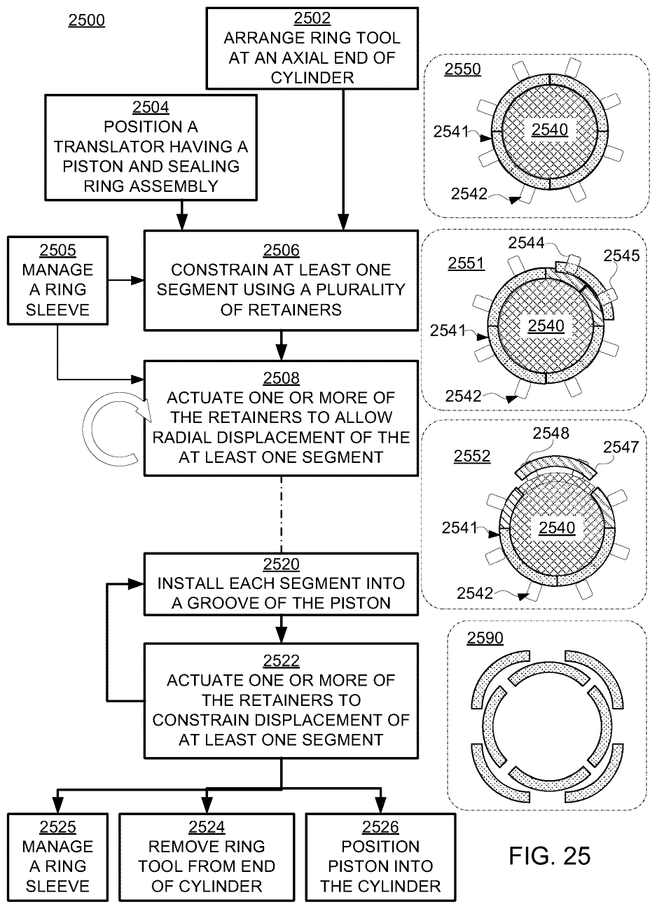

FIG. 25 is a flowchart of illustrative process 2500 for servicing rings, in accordance with some embodiments of the present disclosure. To illustrate, steps 2502-2508 may correspond to removing a ring from a piston, while steps 2520-2524 may correspond to installing a ring into a groove of a piston.

Step 2502 includes arranging a ring tool at an end of a cylinder. Step 2502 may include, for example, axially positioning the ring tool at the end of the cylinder, engaging a lip and groove between the cylinder and ring tool, applying one or more fasteners to secure the ring tool to the cylinder, clamping the ring tool onto the end of the cylinder, engaging one or more locating features to arrange the ring tool relative to the cylinder, securing one or more elements of the ring tool to each other, any other suitable actions for applying the ring tool, or any combination thereof.

Step 2504 includes positioning a translator having a piston and a sealing ring assembly (a “ring”). Step 2504 may be performed before, during (e.g., simultaneous with), or after step 2502. For example, during normal operation, a piston may be axially within the cylinder such that the ring is radially bound by the cylinder. The piston must be moved axially outboard to uncover, or partially uncover, the ring from the bore and allow servicing. In some embodiments, the ring tool is arranged at step 2502 and then the piston is moved to axially line up with the ring tool to allow the ring to be serviced. The piston may be moved axially into place by a control system which automatically advances the piston to a predefined location when a user presses a button or otherwise invokes an electronic command. In some embodiments, when the translator/piston assembly is moved into place, some or all of the generator may be automatically turned off. In some embodiments, the piston is moved outboard of the cylinder and then the ring tool is applied (e.g., a ring compressor, strap, or outer sleeve may be used to constrain the ring until the ring tool is installed).

Step 2505 may be optionally included, for example, if a ring sleeve or compressor (e.g., ring compressor 676 of FIGS. 6-7) is used (e.g., in addition to a tool). Step 2505 includes managing the ring sleeve or compressor to constrain the ring as the tool is installed or otherwise not in place to restrain the ring segments. In some embodiments, a piston is moved axially outboard of the cylinder with the ring sleeve in place (e.g., which may be released from the cylinder such that is moves with the piston), and the tool is installed as the ring sleeve is removed (e.g., the tool is used to slide the ring sleeve rearward on the piston toward or onto the translator tube). In some embodiments a piston is moved axially outboard of the cylinder with the ring sleeve in place (e.g., which may be released from the cylinder such that is moves with the piston), the tool is affixed to the cylinder, and then the piston is moved inboard such the ring slides through the ring sleeve and into the tool.

Step 2506 includes constraining at least one segment of the ring using at least one retainer of a plurality of retainers of the ring tool. Once the ring tool is installed and the ring is axially lined up with the ring tool, retainers of the ring tool may be configured to hold the segments of the ring in the groove of the piston. During ring removal, for example, the initial condition of the retainers may correspond to a first configuration wherein each retainer is in contact with, or within a close proximity (e.g., a length scale less than a radial width of the segment or groove) to one or more segments.

Step 2508 includes actuating one or more of the retainers to allow radial displacement of the at least one segment. As illustrated by the circular arrow, step 2508 may be performed more than once. For example, for each segment of a plurality of segments, a respective set of one or more retainers may be actuated to release the segment, and then another set of retainers may be actuated to release another segment, repeating until all of the plurality of segments are removed. In some embodiments, one or more segments may be constrained by other segments (e.g., in addition to or alternative to a retainer). For example, in some embodiments, when one or more segments are removed, another segment may be freed to be removed (e.g., without further actuation of a retainer).

In an illustrative example, panel 2550 shows ring 2541 installed on piston 2540, with segments (e.g., eight as illustrated, including two four-segment axially stacked rings, as shown in panel 2590) held in place by retainers 2542 at step 2506. As retainers 2544 are actuated (e.g., actuated exclusive of other retainers to maintain other segments) at step 2508 in panel 2551, segment 2545 is able to be removed (e.g., by displacing retainers radially and/or axially and then segment 2545 axially). Further, as retainer 2548 is actuated, segment 2547 is able to be removed, while retainer 2542 (and others) continue to constrain other segments. To illustrate further, for ring installation, the process may be reversed, and may progress from panel 2552 to 2551 to 2550.

Step 2520 includes installing a segment of the ring into the groove of the piston. In some embodiments, prior to step 2520, steps 2502 and 2504 may be performed, and the retainers may be in a second configuration wherein the segments can fit into the groove without being blocked by the retainers. Step 2520 may include placing a segment at a predetermined azimuthal piston on the piston (e.g., piston 2540), corresponding to one or more first retainers.

Step 2522 includes actuating one or more of the retainers to constrain radial displacement of the at least one segment. Steps 2520 and 2522 may be performed more than once (e.g., for each segment, in sequence). For example, for each segment of a plurality of segments, a respective set of one or more retainers may be actuated to constrain the segment once installed, and then another set of retainers may be actuated to constrain another segment once installed, repeating until all of the plurality of segments are installed. For example, steps 2520 and 2522 may be repeated for each segment, including placing the segment and then constraining the segment, and then repeating for the next segment. In some embodiments, one or more segments may be constrained by other segments (e.g., in addition to or alternative to a retainer). For example, in some embodiments, when one or more segments are installed, another segment may be constrained by the one or more segments (e.g., without further actuation of a retainer).

Step 2524 includes removing the ring tool from the end of the cylinder. Step 2524 may include, for example, removing the ring tool at the end of the cylinder, disengaging a lip and groove between the cylinder and ring tool, removing one or more fasteners to release the ring tool from the cylinder, releasing a clamp, disengaging one or more locating features to release the ring tool from the cylinder, releasing one or more elements of the ring tool from each other, any other suitable actions for removing the ring tool, or any combination thereof. In some embodiments, step 2522 may include sliding a sleeve or collar at least partially over the ring from the piston side of the ring to retain the segments while the ring tool is removed.

Step 2526 includes positioning a translator having a piston and a sealing ring assembly (a “ring”). Step 2526 may be performed before, during (e.g., simultaneous with), or after step 2524. For example, during servicing, a piston may be axially outboard of the cylinder such that the ring is not radially bound by the cylinder. The piston must be moved axially inboard to bound the ring with the bore of the cylinder. In some embodiments, the ring tool is removed at step 2524 and then the piston is moved to axially place the ring in the cylinder. In some embodiments, the piston is moved inboard of the cylinder and then the ring tool is removed (e.g., a ring compressor or strap may be used to constrain the ring until the ring is in the cylinder).

Step 2525 may be optionally included, for example, if a ring sleeve or compressor (e.g., ring compressor 676 of FIGS. 6-7) is used (e.g., in addition to a tool). Step 2525 includes managing the ring sleeve or compressor to constrain the ring as the tool is removed or otherwise not in place to restrain the ring segments. In some embodiments, a ring or segment thereof is installed (or re-installed), inspected, or otherwise serviced with a ring sleeve positioned on the translator (e.g., freely hanging from the piston and axially offset from the ring such that it is out of the way). Once the ring has been serviced, with the ring tool in place, the ring sleeve is moved over the ring (e.g., to slide the ring tool axially off of the piston) to displace the tool. In some embodiments, once the ring sleeve constrains the ring, the piston is moved inboard until the ring sleeve interfaces with the end of the cylinder. The ring sleeve may then be affixed to the cylinder, and the piston may be further moved inboard such that the ring is constrained by the bore of the cylinder.

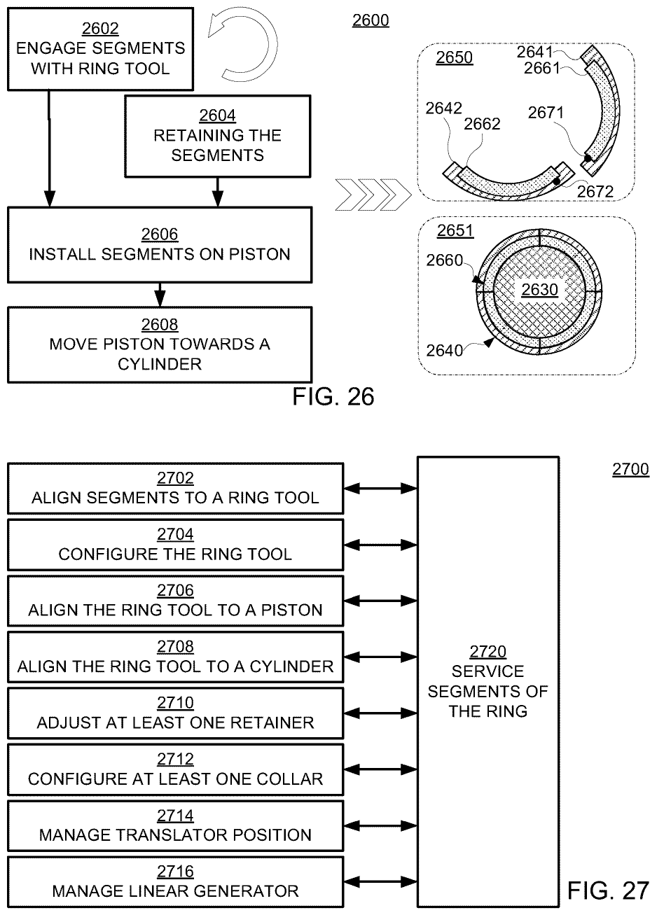

FIG. 26 is a flowchart of illustrative process 2600 for servicing rings, in accordance with some embodiments of the present disclosure.

Step 2602 includes engaging one or more segments of a ring with one or more elements of a ring tool. In some embodiments, one or more rings segments are engaged with a ring tool or element thereof. For example, one or more features of the ring tool may interface to one or more features of a ring segment to align the relative positions. To illustrate, a ring segment may include a notch, hole, or lip, and the ring tool element may include a pin, ridge, or mating lip to hold the segment. In some embodiments, a retainer is installed once the ring segment and the ring tool element are interfaced. For example, the retainer may act as a feature to lock the segment and element together. In a further example, if included, a retainer may include a pin, a tab, a wedge, any other suitable component for aligning the ring segment to the ring tool element, or any combination thereof. In some embodiments, one or more ring segments may be engaged with a ring tool element (e.g., two ring segments may be engaged with an element). In some embodiments, one or more ring tool elements may be engaged with a single ring segment (e.g., two ring segments may be engaged with more than one ring tool elements). In some embodiments, engaging the segment to the element includes clocking the segment relative to the element such that the segment is arranged at a particular azimuthal orientation relative to the element (e.g., to result in a target clocking of the segment when installed on the piston).

Step 2604 includes retaining the ring segments after engagement at step 2602. Once a segment is engaged with an element of a ring tool, a retainer may be installed to lock the ring segment to the element, maintain alignment, or a combination thereof. In some embodiments, step 2604 may include engaging two elements together to lock the engaged ring segments into place. In some embodiments, step 2602 and 2604 may be combined by engaging the segments such that they are retained (e.g., by one or more mating features of the segment and element).

Step 2606 includes installing the ring segments onto the piston. For example, step 2606 may include arranging the ring tool relative to a piston. Once each segment of the ring has been engaged with the ring tool at step 2602 (e.g., which may be repeated for each ring segment), the ring tool may be arranged relative to a piston. In some embodiments, the ring tool may be installed around a piston such that the ring is arranged in a groove of the piston. In some embodiments, steps 2602 and 2604 may be combined. For example, as one or more ring segments are engaged with one or more ring tool elements to form a subassembly, the subassembly may then be arranged relative to a piston such that the one or more ring segments are arranged in a groove of a piston. In some embodiments, for example, the ring tool may be clocked to the piston (e.g., azimuthally aligned), and then moved radially inward onto the piston (e.g., such that the ring segments are inserted radially into the groove).

Step 2608 includes moving the piston into the cylinder such that the bore bounds the ring. In some embodiments, step 2608 includes installing a ring sleeve such that the ring tool can be removed. For example, a ring sleeve may be axially slid onto the ring, while the ring is compressed by the ring tool, to displace the ring tool. In some embodiments, the ring tool and piston assembly are moved toward the end of the cylinder such that the ring is arranged in the bore, and the ring tool is axially displaced to the rear of the piston (e.g., for a central cylinder having opposed pistons). In some embodiments, the ring tool and piston assembly are moved to and into the end of the cylinder, and the ring tool is axially displaced to the front of the piston (e.g., for an end cylinder having a head such as a gas spring cylinder).

In an illustrative example, panel 2650 illustrates ring tool elements 2641 and 2642, with respective ring segments 2661 and 2662 engaged. Retainers 2671 and 2672, which may include tabs, pins, holes, steps, any other suitable features, or any combination thereof that may mate to a surface or mating feature of respective ring segments 2661 and 2662. Panel 2651 illustrates ring 2660, which includes ring segments 2661 and 2662, arranged in a groove of piston 2630, held in place by ring tool 2640, which includes ring tool elements 2641 and 2642. In some embodiments, retainers 2671 and 2672 may be removed once ring tool 2640 is assembled or otherwise ring 2660 is installed on piston 2630. In some embodiments, retainers 2671 and 2672 need not be removed once ring tool 2640 is assembled or otherwise ring 2660 is installed on piston 2630, and may be maintained in place to constrain ring 2640.

FIG. 27 is a flowchart of an illustrative process 2700 for servicing rings, in accordance with some embodiments of the present disclosure. To illustrate, steps 2702-2716 may be performed prior to servicing at step 2720 such as during position and preparing the ring segments to be removed or inspected. Further, steps 2702-1716 may be performed after servicing at step 2720 to allow re-insertion of the ring (and piston) into a bore of a cylinder. Accordingly, the steps of process 2700 may be performed in any suitable order, omitted, combined, or otherwise modified in accordance with the present disclosure. Process 2700 may be used to service any of the rings or segments of the present disclosure, for example.

Step 2702 includes aligning one or more segments to one or more elements of a ring tool. Step 2702 may include, for example, aligning one or more features of a segment with one or more mating features of an element to align, constrain, indicate, or otherwise manage relative positions of the segment and element. Alignment may include axial alignment, relative lateral alignment (e.g., radial, azimuthal, or both between the segment and element), absolute lateral alignment (e.g., radial, azimuthal, or both between the segment and/or element and another reference), or a combination thereof.

Step 2704 includes configuring the ring tool. Step 2704 may include, for example assembling the ring tool by affixing a plurality of elements together (e.g., before, during, or after installation of segments). In some embodiments, step 2704 may include steps 2702 or 2710, or aspects thereof, to achieve one or more states of the ring tool.

Step 2706 includes aligning the ring tool to a piston. Step 2706 may include axially aligning the ring tool, laterally aligning the ring tool, or a combination thereof, performed sequentially or simultaneously. For example, the piston may include a groove and a face, and the ring tool may be aligned laterally to the groove, axially to the face or a land of the groove, or a combination thereof. In some embodiments, step 2706 includes fastening, clamping, or otherwise affixing the ring tool to the piston to maintain alignment. In some embodiments, the piston, ring tool, or both include one or more locating features that may engage or interface to a feature, surface, or other aspect of the other.

Step 2708 includes aligning the ring tool to a cylinder. Step 2708 may include axially aligning the ring tool, laterally aligning the ring tool, or a combination thereof, performed sequentially or simultaneously. For example, the cylinder may include a bore and an axial end (e.g., of two axial ends), and the ring tool may be aligned laterally to the bore (e.g. or the piston, which may be aligned to the bore), axially to the end of the cylinder, or both. In some embodiments, step 2708 includes fastening, clamping, or otherwise affixing the ring tool to the cylinder to maintain alignment. In some embodiments, the cylinder, ring tool, or both include one or more locating features that may engage or interface to a feature, surface, or other aspect of the other.

Step 2710 includes adjusting at least one retainer of the ring tool. In some embodiments, the at least one retainer is part of the ring tool, and may be configured to achieve one or more positions, orientations, or both of the ring within the ring tool. In some embodiments, the at least one retainer may be a separate component that is installed to retain a ring segment against a ring tool element (e.g., a body element). A retainer may include a pin, tab, step, lip, or other boss feature, or a corresponding recess feature such as a hole, slot, or cutaway. For example, the retainer may include a first feature and the ring segment may include a second feature configured to mate with the first feature using any suitable mechanical interface.

Step 2712 includes configuring at least one collar, ring sleeve, or ring compressor. For example, a component such as ring compressor 676 or any other suitable component may be used to transition among the ring being bound by the cylinder, bound by the ring tool, or fully or partially unbound. The component may be azimuthally continuous (e.g., extending fully around the ring without an interface), or may be segmented. In some embodiments, the component may be part of the linear generator during normal operation, although it need not be (e.g., the component may optionally be another tool used during servicing but not included during operation).

Step 2714 includes managing translator position. Step 2714 may include manual manipulation of the translator by a technician, or automated positioning using a stator-translator interaction or a separate “puller” tool mounted to a frame or other stationary component (e.g., affixed to the translator, and having a motor and manual mechanism for axially moving the translator). To illustrate, the linear generator may include a linear encoder or other position sensor that may be referenced during servicing to ensure repeatable and accurate positioning of the piston and/or ring. In some embodiments, positioning may be based on a user's preferences, without sensor feedback or strict references (e.g., reference positions or hard stops), and need not be limited to predetermined positions (e.g., during an inspection).

Step 2716 includes managing one or more systems of a linear generator. Step 2716 may include controlling or monitoring currents in a stator (e.g., using power electronics and a DC bus), sensor signals (e.g., to determine pressures, positions, voltages, currents), or other electronics, and also mechanically managing components and systems (e.g., assembling, disassembling, modifying). For example, one or more components may be removed to provide access during ring servicing. In a further example, a DC bus may be managed to help achieve step 2714 (e.g., using a linear electromagnetic machine of the stator and translator) or otherwise reduce a maximum voltage (e.g., during manual steps near current carriers). In a further example, a bearing system (e.g., a gas bearing system) may be managed to allow the translator and corresponding piston(s) to be moved.

Step 2720 includes servicing segments of the ring. Servicing may include inspecting (e.g., visually or using an imaging device), measuring (e.g., manually or using an automated metrology tool), installing, removing, cleaning, any other suitable interaction with the ring or segments thereof, or any combination thereof. For example, an entire ring may be serviced, or one or more segments thereof may be serviced (e.g., a broken segment may be replaced).

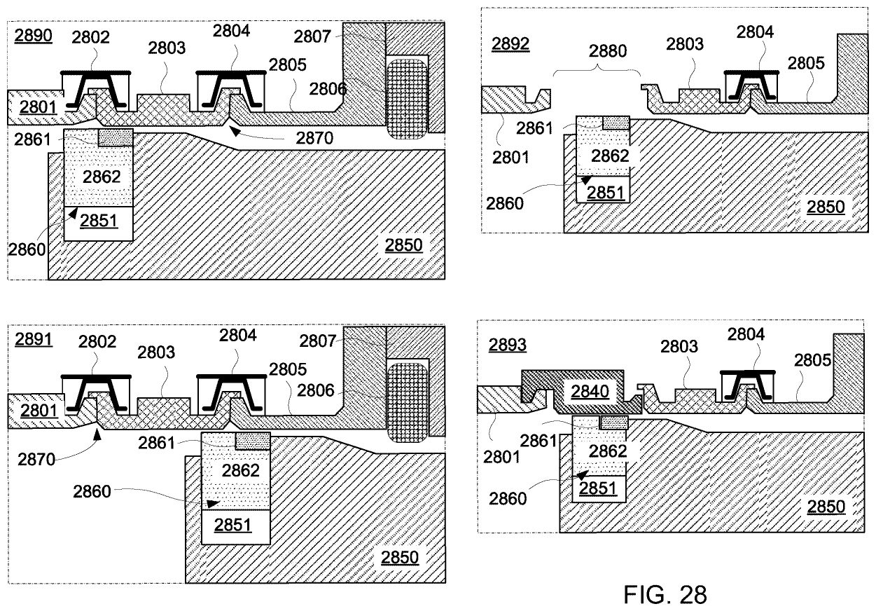

FIG. 28 shows a series of cross-sectional views of a region of a linear generator during ring servicing, in accordance with some embodiments of the present disclosure. To illustrate, any or all steps of processes 2500, 2600, and 2700 of FIGS. 25-27 may be implemented during ring servicing as illustrated in FIG. 28. Panels 2890, 2891, 2892, and 2893 illustrate stages of an exemplary servicing, illustrative components, and potential configurations that may be achieved.

Panel 2890 illustrates an assembly of cylinder 2801, first sleeve 2803 (e.g., coupled to cylinder 2801 by clamp 2802), second sleeve 2805 (e.g., coupled to component 2803 by clamp 2804), seal 2806 (e.g., that does not move with piston 2850 during operation), and seal retainer 2807 (e.g., affixed to component 2805). Piston 2850 includes groove 2851, in which ring 2860 is arranged (e.g., segments 2861 and 2862 thereof are arranged). To illustrate, the configuration of panel 2890 may correspond to a normal operating configuration, although in some circumstances, piston 2850 might not normally operate with ring 2860 beyond the end of cylinder 2801 (e.g., be axially bound well inside of the end of cylinder 2810). Each of cylinder 2801, first sleeve 2803, and second sleeve 2805 may include tapers or otherwise lead-ins (e.g., illustrated by features 2870 in FIG. 28) that avoid abrupt step changes in the bore as ring 2860 moves axially past the interfaces.

Panel 2891 illustrates piston 2850 moved axially outboard relative to the position illustrated in panel 2890. As illustrated in panel 2891, ring 2860 is axially outboard of cylinder 2801, constrained instead by sleeve 2803 or sleeve 2805. For example, the configuration of panel 2891 may occur during translator positioning at step 2714 of FIG. 27.

Panel 2892 illustrates an intermediate configuration, wherein ring 2860 is not bound and is free to expand (e.g., into open area 2880), for example because the rings are biased radially outward by a spring and, at some locations, pulled downward by gravity. This intermediate configuration may be avoided during servicing by implementing suitable steps to maintain lateral constraints on ring 2860. For example, before sleeves 2803 and 2805 are moved axially outboard, or before piston 2850 is moved axially outboard of cylinder 2801, a ring tool may be installed to prevent ring 2860 from displacing outward (e.g., due to gravity, perturbation by a user, or spring forces).

Panel 2893 illustrates a servicing configuration wherein sleeves 2803 and 2805 are moved axially outboard, ring tool 2840 is installed (e.g., step 2708 of FIG. 27), and piston 2850 and ring tool 2840 are axially aligned with each other (e.g., at step 2714 of FIG. 27, in that order or any other suitable order. For example, once ring tool 2840 is installed (e.g., by affixing to cylinder 2801, sleeve 2803, or both), each segment of ring 2860 may be removed, inspected, or replaced. To illustrate, one or more elements of ring tool 2840 may be engaged with segments 2861 and 2862 (e.g., at steps 2702 and/or 2710 of FG. 27) and may be removed or moved with the respective segments.

In an illustrative example, in some embodiments, a power cylinder air plug (PCAP) assembly (e.g., including sleeves 2803 and 2805, seal 2806, and seal retainer 2807) may be designed for use of a ring tool. For example, sleeve 2803 may be used for ring servicing. In some embodiments, sleeves 2803 and 2805, and ring tool 2840 may include one azimuthal element (e.g., continuous or with a split), more than one azimuthal element, or otherwise a plurality of azimuthal elements. Some embodiments may include only one sleeve. For example, the arrangement described above with respect to FIG. 28 may pertain to an exhaust side of a power cylinder in a linear generator while the intake side may not have a seal or a second sheath; operationally, the procedure for servicing, installing, or removing a ring may be otherwise the same as described above.

In an illustrative example, servicing may include (e.g., with reference to process 2700):
shutting down a linear generator from operation (e.g., at step 2716);
move the translator outboard to a ring change position (e.g., at steps 2714 and/or 2716);
achieve a ring change position (e.g., at steps 2714 and/or 2716);
if applicable, turn off power (e.g., at step 2716), such as 480VAC or a DC bus;
disconnect an assembly (e.g., remove clamps 2802 and 2804), and then move assembly outboard to provide access to ring 2860 (e.g., at steps 2712 and/or 2716), and install ring tool 2840 (e.g., at step 2708), in a suitable order;
remove ring 2860 and install new ring (e.g., at step 2720), managing ring tool 2840 if applicable;
translate sleeve 2803 to partially overlap with the new ring outer diameter;
shift assembly inboard to engage with cylinder 2801 (e.g., install clamps 2802 and 2804), removing ring tool 2840 if applicable (e.g., at steps 2704, 2706, 2708, 2812, and 2814); and
reassemble the system, and operate the linear generator (e.g., at step 2716).

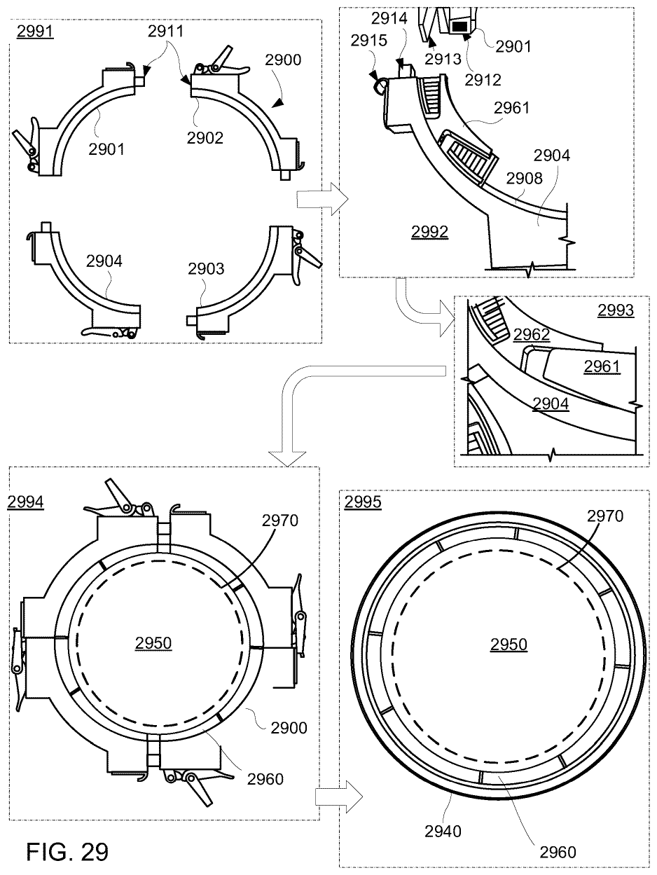

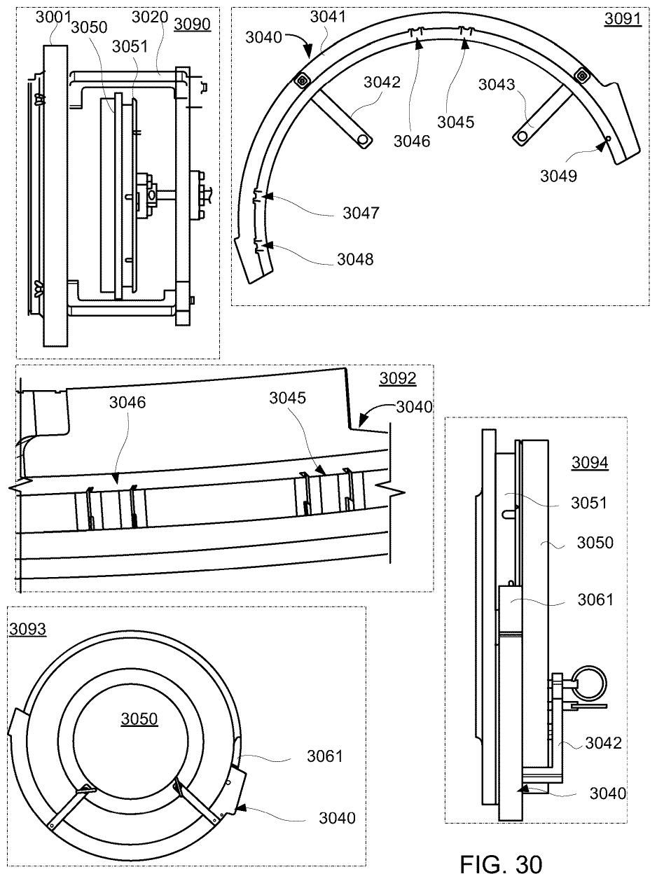

FIG. 29 shows a series of face views of ring tool 2900, piston 2950, and ring sleeve 2940 (e.g., a collar) during installation, in accordance with some embodiments of the present disclosure. Panel 2991 illustrates ring tool 2900 having elements 2901-2904 and corresponding interfaces (e.g., interface 2911 being one of four, as illustrated). Panel 2991 illustrates an unassembled configuration of ring tool 2900 (e.g., ready to receive segments of a ring). Panel 2992 illustrates element 2904 having feature 2908 (e.g., illustrated as a step), with segment 2961 engaged. Panel 2992 also illustrates mating features 2912 and 2914 (e.g., a boss feature and a corresponding recess) of respective elements 2901 and 2904, which are configured to interlock when ring tool 2900 is assembled. Panel 2992 also illustrates latch features 2913 and 2915 of respective elements 2901 and 2904, which are configured to engage to secure elements 2901 and 2904 when ring tool 2900 is assembled. Each interface may include mating features and latch features. Panel 2993 illustrates element 2904, with segments 2961 and 2962 engaged. Panel 2994 illustrates ring tool 2900, which constrains ring 2960, being arranged and secured around piston 2950. For example, as illustrated, two opposing interfaces are secured and latched and then the remaining two interfaces are shown in the process of being engaged such that the mating features are engaging before being closed and latched (e.g., to hold ring 2960 in a groove of piston 2950). Sealing ring 2970 represents where a sealing ring may be arranged for installation in a ring groove on a surface of piston 2950. Sealing ring 2970 is configured to form a seal with a bore of a cylinder in which piston 2950 is arranged based on one or more of pressurized fluid or gas being introduced into the ring groove behind a surface of sealing ring 2970 or in response to a spring being arranged along a portion of sealing ring 2970 such that the spring is configured to press one or more sections of sealing ring 2970 radially outwards towards the bore.

In an illustrative example, using ring tool 2900 may include the following steps (e.g., with reference to process 2700):
engage segment 2961 with element 2904 (e.g., step 2702 and optionally step 2710);
engage with retainer (feature 2908) to hold segment 2961 in place (e.g., step 2710);
repeat for each segment and element (e.g., a ring tool may have at least one element);
assemble elements 2902 and 2903 and elements 2901 and 2904 to form two subassemblies (e.g., step 2704);
assemble two subassemblies together around the piston (e.g., step 2704 and 2706); and
slide ring sleeve 2940 axially onto piston 2950 while axially removing ring tool 2900 such that ring sleeve 2940 replaces ring tool 2900 to constrain ring 2960.

FIG. 30 shows a series of views of a ring tool (e.g., including element 3040), positioner 3020, and piston 3050 during installation (e.g., into cylinder assembly 3001), in accordance with some embodiments of the present disclosure. Panel 3090 illustrates positioner 3020 affixed to piston 3050 and affixed to cylinder assembly 3001. Positioner 3020 may be configured to axially move piston 3050 while allowing lateral access to groove 3051 of piston 3050 (e.g., to service a ring). Panel 3091 illustrates element 3040 of a ring tool, including features 3042 and 3043 for axially engaging with piston 3050, feature 3049 for engaging with a retainer (e.g., a hole configured to receive a pin), and features 3045-3048 configured to engage with segments of the ring (e.g., segment 3061). Panel 3092 illustrates an enlargement of features 3045 and 3046, which are configured to engage with mating features of a ring segment 3061 to locate the segment azimuthally on the element 3040. Panel 3093 illustrates a face view of piston 3050, with element 3040 installed with segment 3061 (and optionally any other suitable segments not visible in FIG. 30). Panel 3094 illustrates a side view of the same configuration as panel 3093. Panel 3094 illustrates element 3040 engaged with piston 3050, feature 3042 axially engaged with a face of piston 3050, and segment 3061 arranged in groove 3051 of piston 3050. For example, another element with one or more ring segments may then be installed, and positioner 3020 may be used to move piston 3050 axially into cylinder assembly 3001 as the ring tool is removed.

In an illustrative example, using ring tool 2900 may include the following steps (e.g., with reference to process 2700):
insert a segment (e.g., a front ring) on tabs (e.g., of features 3045-3048) at the edge of the bottom half of the tool (e.g., steps 2702 and optionally step 2710);
insert pin and spring into the segment (e.g., at step 2710);
engage another segment (e.g., a rear ring) with the first segment and the element (e.g., steps 2702 and optionally 2710);
retain the second segment (e.g., step 2710);
compress the segments (e.g., compress a spring) to engage the second segment with tabs (e.g., features 3045-3048) (e.g., step 2702);
optionally repeat for other elements of the ring tool (e.g., steps 2702 and 2704);
prepare, clean, and/or inspect groove 3051 (e.g., before or during step 2706);
insert half of the tool (e.g., element 3040) into groove 3051 (e.g., step 2706);
engage the ring tool with positioner 3020 (e.g., at step 2708 and optionally 2714);
complete assembly of the ring tool with any remaining elements (e.g., step 2704);
use positioner 3020 to move piston 3050 into cylinder assembly 3001 (e.g., step 2714); and
remove positioner 3020 and the ring tool in any suitable order (e.g., steps 2704, 2714, and 2716).

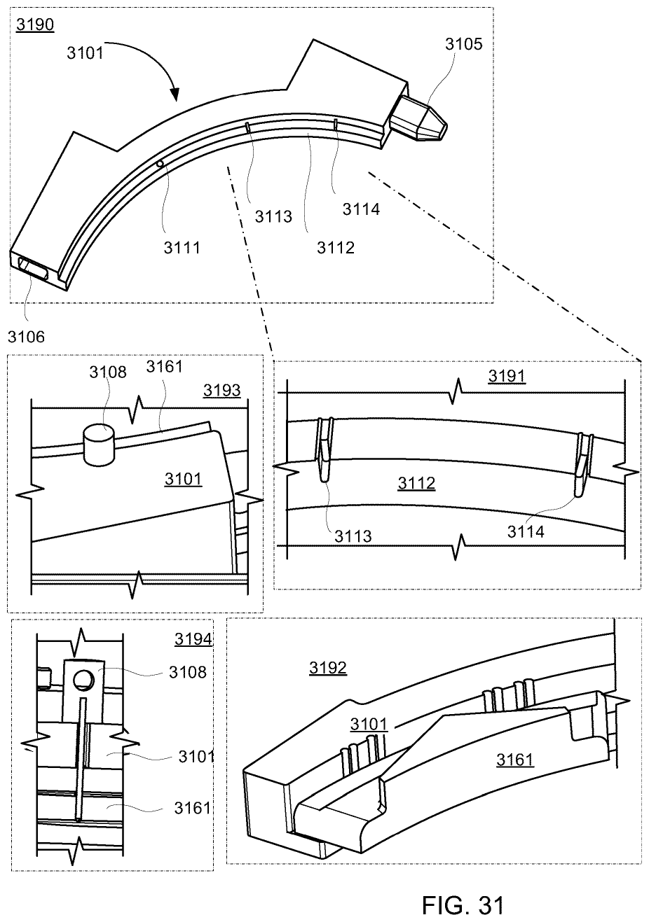

FIG. 31 shows aspects of illustrative ring tool (e.g., element 3101 thereof), in accordance with some embodiments of the present disclosure. Panel 3190 illustrates element 3101, which may be one of N elements of a ring tool (e.g., one of four as illustrated). Panel 3191 illustrates an enlargement of element 3101 to illustrate features 3112, 3113, and 3114. Panels 3192 and 3193, from axially opposite views, illustrate segment 3161 engaged with element 3101, retained with retainer 3108 (e.g., which constrains at least one degree of freedom of a segment relative to an element). Panel 3194 illustrates a cross-sectional view of retainer 3108 (e.g., having a pin and a head) extending through element 3101 into a hole of segment 3161. Element 3101 includes feature 3106 (e.g., a recess, as illustrated) for engaging with another element (e.g., having a boss similar to feature 3105), feature 3105 (e.g., a boss, as illustrated) for engaging with another element (e.g., having a hole or recess similar to feature 3106), feature 3111 for engaging with retainer 3108 (e.g., a pin), and features 3112-3114 for engaging with a ring segment (e.g., segment 3161). Feature 3111, as illustrated, includes a hole into which a pin (e.g., retainer 3108) may be inserted to secure a ring segment (e.g., a pin may be inserted into ring segment 3161).

Features 3113 and 3114, as illustrated, include tabs that engage with recesses (e.g., mating features) of a ring segment to prevent azimuthal displacement. Feature 3112, as illustrated, includes a step against which the ring segment may be constrained from moving radially outwards or axially.

In an illustrative example, a ring tool or element thereof (e.g., element 3101), may include and suitable material such as ABS, nylon, acrylic, Delrin, HDPE, PEEK, PTFE, LDPE, aluminum, any other suitable material, or any combination thereof. For example, a ring tool may include a body made of a first material (e.g., plastic), and clamps, latches, or other fastening mechanisms that may be made of a second material (e.g., metal).

It will be understood that the present disclosure is not limited to the embodiments described herein and can be implemented in the context of any suitable system. In some suitable embodiments, the present disclosure is applicable to reciprocating devices such as linear generators. In some embodiments, for example, the present disclosure is applicable to engines and compressors. In some embodiments, the present disclosure is applicable to combustion and reaction devices such as a reciprocating engine and an engine. In some embodiments, the present disclosure is applicable to non-combustion and non-reaction devices such as reciprocating compressors and compressors. In some embodiments, the present disclosure is applicable to gas springs. In some embodiments, the present disclosure is applicable to oil-free reciprocating and engines and compressors. In some embodiments, the present disclosure is applicable to oil-free devices with internal or external chemical reactions. In some embodiments, the present disclosure is applicable to oil-free devices that operate with compression ignition (e.g., homogeneous charge compression ignition, stratified charge compression ignition, or other compression ignition), spark ignition, or both. In some embodiments, the present disclosure is applicable to oil-free devices that operate with gaseous fuels, liquid fuels, or both. In some embodiments, the present disclosure is applicable to linear generators having one or more translators. In some embodiments, the present disclosure is applicable to engines that can be combustion engines with internal combustion/reaction or any type of heat engine with external heat addition (e.g., from a heat source or external reaction such as combustion).

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. An apparatus comprising:
at least one element configured to interface to an end of a cylinder; and
a plurality of retainers configured to constrain a sealing ring assembly, wherein:
in a first configuration, at least one retainer of the plurality of retainers constrains at least one segment of the sealing ring assembly in a groove of a piston; and
in a second configuration, the at least one retainer of the plurality of retainers is axially offset from at least one segment such that the at least one segment is radially removeable.

2. The apparatus of claim 1, further comprising a flange extending radially inward from the at least one element to partially obstruct a bore of the cylinder to constrain axial displacement of the piston into the bore of the cylinder, wherein the flange is configured to block the piston from moving into the bore.

3. The apparatus of claim 1, wherein the at least one element comprises at least two azimuthal segments.

4. The apparatus of claim 1, wherein the sealing ring assembly is arranged in a groove of the piston and is configured to seal against both a land of the piston and a bore of the cylinder, and wherein the at least one element further comprises at least one mounting feature configured to be engaged with the cylinder.

5. The apparatus of claim 1, wherein:
each respective retainer comprises a respective first feature; and
the at least one element comprises a plurality of second features, wherein the apparatus further comprises a plurality of tethers that couple each respective first feature to a respective second feature of the plurality of second features such that each respective retainer is tethered to the at least one element.

6. The apparatus of claim 1, wherein:
the plurality of retainers each comprise a respective head and a respective pin;
the at least one element comprises a plurality of axial holes;
each respective pin is configured to move axially in a respective axial hole of the plurality of axial holes; and
each respective head is configured to contact the sealing ring assembly to prevent radial displacement of one or more segments of the sealing ring assembly.

7. The apparatus of claim 6, wherein each retainer of the plurality of retainers is axially biased by a spring.

8. The apparatus of claim 1, wherein the plurality of retainers each comprise a respective disc configured to contact the sealing ring assembly to prevent radial displacement of one or more segments of the sealing ring assembly.

9. The apparatus of claim 1, wherein the plurality of retainers each comprise a respective asymmetric washer configured to:
achieve a first angular orientation and a second angular orientation;
at the first angular orientation, prevent radial displacement of one or more segments of the sealing ring assembly; and
at the second angular orientation, allow radial displacement of the one or more segments of the sealing ring assembly.

10. The apparatus of claim 1, wherein:
the plurality of retainers each comprise a respective head and at least two respective pins;
each respective head comprises a respective radial width and a respective azimuthal length; and
the respective radial width is less than the respective azimuthal length.

11. An apparatus comprising:
a first element configured to engage with a first ring segment of a sealing ring assembly to form a first subassembly; and
a second element configured to engage with the first element and to engage with a second ring segment of the sealing ring assembly to form a second subassembly, wherein:
the first and the second subassemblies are configured to be engaged with each other and arranged azimuthally around a groove of a piston, and
the first and second element are configured to be removed before operation.

12. The apparatus of claim 11, wherein:
the first element comprises at least one first feature configured to be engaged with a mating feature of the first segment; and
the second element comprises at least one second feature configured to be engaged with a mating feature of the second segment.

13. The apparatus of claim 11, wherein:
the first element comprises at least one first mounting feature configured to be engaged with the piston; and
the second element comprises at least one second mounting feature configured to be engaged with the piston.

14. The apparatus of claim 11, further comprising at least one retainer configured to interface with the first segment and with the first segment to retain the first segment and the first element together in at least one degree of freedom.

15. A method for servicing a sealing ring assembly that seals against a piston and a cylinder of a linear generator, the method comprising:
engaging a respective segment of the sealing ring assembly to a respective element of a plurality of elements of a ring tool;
configuring the plurality of elements such that the sealing ring assembly is arranged in a groove of piston; and
positioning the piston such that the sealing ring assembly is laterally bound by one or more of the cylinder or the ring tool to retain the rings in place in the groove of the piston.

16. The method of claim 15, further comprising blocking the piston from entering the cylinder using a flange.

17. The method of claim 15, further comprising removing the ring tool after positioning the piston.

18. A method for servicing a sealing ring assembly that seals against a piston and a cylinder of a linear generator, the method comprising:
arranging a ring tool at an axial end of the cylinder;
positioning the piston such that the sealing ring assembly is axially proximal to the ring tool;
constraining at least one segment of the sealing ring assembly using a plurality of retainers of the ring tool; and
actuating one or more retainers of the plurality of retainers to allow radial displacement of the at least one segment.

19. The method of claim 18, further comprising installing a ring sleeve to retain the sealing ring assembly during the positioning of the piston, wherein arranging the ring tool at the axial end of the cylinder is performed after installing the ring sleeve.

20. The method of claim 18, wherein constraining the at least one segment using the plurality of retainers comprises achieving a first respective axial position of each respective retainer of the plurality of retainers, and wherein actuating the one or more retainers of the plurality of retainers to allow radial displacement of the at least one segment comprises achieving a second respective axial position of each respective retainer of the plurality of retainers.

21. The method of claim 20, further comprising maintaining at least one retainer exclusive of the plurality of retainers to constrain another segment of the sealing ring assembly exclusive of the at least one segment.

22. A method for servicing a sealing ring assembly that seals against a piston and a cylinder of a linear generator, the method comprising:
positioning the piston into a ring change position such that the piston is outside of the cylinder;
constraining the ring assembly with a sleeve to block radial displacement of the ring assembly;
attaching a ring tool having one or more ring retainers at an axial end of the cylinder such that the one or more ring retainers contact an outer radial surface of the ring assembly;
removing the sleeve off of the ring assembly;
depressing the ring retainers such that they move off of the ring assembly; and
removing the ring assembly.

23. The method of claim 22 further comprising:
depressing the ring retainers to allow space for the ring assembly to be incrementally inserted;
incrementally inserting the ring assembly into a ring groove of the piston while releasing the ring retainers to capture the ring assembly in the ring groove;
constraining the ring assembly with a sleeve to block radial displacement of the ring assembly;
removing the ring tool from the piston;
translating the piston partially into the cylinder such that the cylinder inhibits radial displacement of the ring assembly from an initial installation position; and
removing the sleeve.

24. The method of claim 22, wherein the step of positioning the piston into the ring change position is accomplished by a control system causing positioning via stator-translator interaction.

25. A device for servicing a sealing ring of a piston comprising:
a first element configured to engage with a first ring segment of a sealing ring assembly; and
a second element configured to engage with the first element and to engage with a second ring segment of the sealing ring assembly, wherein:
the first and the second elements are configured to be engaged with each other and arranged azimuthally around a groove of a piston to constrain the sealing ring assembly when positioned axially outside of a bore of a cylinder.

26. The device of claim 25, further comprising a flange configured to block the piston from entering the cylinder.

27. The device of claim 25, wherein the device is configured to be removed from the piston after the piston is positioned relative to the cylinder.

28. The device of claim 25, wherein:
the device is configured to interface with a ring sleeve to retain one or more of the first segment or the second segment during positioning of the piston; and
the device is configured to be arranged at the axial end of the cylinder after the ring sleeve is installed.

29. The device of claim 25, further comprising a plurality of retainer configured to constrain one or more of the first segment or the second segment.

30. The device of claim 29, wherein one or more of the plurality of retainers allow radial displacement of one or more of the first segment or the second segment.
